(19) United States
(12) Patent Application Publication
(10) Pub. No.: US 2006/0061817 A1
(43) Pub. Date: Mar. 23, 2006

(54) Print system, print control method and job processing method

(76) Inventors: Nobuyoshi Kakigi, Kanagawa-ken (JP); Kazuhiko Ushiyama, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/231,564

(22) Filed: Sep. 21, 2005

(30) Foreign Application Priority Data
Sep. 21, 2004 (JP) 2004-273977
Sep. 6, 2005 (JP) 2005-258313

(51) Int. Cl. G06F 3/12

(52) U.S. Cl. 358/1.15

(57) ABSTRACT

For making use of a system as effectively as possible, a request related to distributed printing for performing printing process using a first printing apparatus and a second printing apparatus can be accepted, and printing process of data for the distributed printing can be performed by the second printing apparatus under processing conditions different from processing conditions in printing process of data for the distributed printing by the first printing apparatus.

### FIELD OF THE INVENTION

The present invention relates to a print system, a print control method, a job processing method, a local printing apparatus, a storage medium and a program.

### BACKGROUND OF THE INVENTION

With advancement of network techniques in recent years, printing apparatuses such as printers, facsimiles and copiers adapting to networks have come into practical use. A print system connecting such printing apparatuses to a network and performing processing in which these apparatuses are coupled (collaborate) has been proposed.

In this print system, there is a printing apparatus to which a user first provides an instruction of printing operation with the intention of use in printing. In other words, there is a printing apparatus first directly accepting an instruction from the user. In this specification, a printing apparatus corresponding to such a printing apparatus is also called a local printing apparatus.

There is other printing apparatus of a distributive print (cluster printing) partner or a (alternative printing) partner substitutively performing processing. In this specification, a printing apparatus corresponding to such a printing apparatus is also called a remote printing apparatus.

In this system, a proposition has been made to perform processing in which a plurality of printing apparatuses of local printing apparatuses and remote printing apparatuses collaborate.

In this specification, an operation in which printing is not carried out by the local printing apparatus but is carried out only by the remote printing apparatus is also called remote print. An operation in which printing is performed by both the local printing apparatus and remote printing apparatus is also called cluster printing.

In the cluster printing in which printing is performed distributively, for example, a proposition has been made to allocate the number of print copies dealt with by the local printing apparatus and the number of print copies dealt with by the remote printing apparatus according to the printing speed of each printing apparatus (see Patent Document 1).

It has been proposed that in case where an error occurs in a printing apparatus during cluster printing, a remaining print job is transferred to other printing apparatus having no error to perform recovery (see Patent Document 2).

[Patent Document 1] Japanese Patent Laid-Open No. 2001-100963

[Patent Document 2] Japanese Patent Laid-Open No. 2003-198781

However, the configuration in which cluster printing is carried out by the above-mentioned print system is based on the major premise that “each apparatus can achieve an equivalent function/equivalent processing”. In other words, it seems that an environment where cluster printing and alternative printing can be performed has limitations. For example, it seems that such an environment is nothing more than an environment where the above-mentioned processing can be achieved among printing apparatuses of the same series or printing apparatuses having equivalent functions. A configuration in which the capacities of the printing apparatuses are compared in the above-mentioned system is certainly under consideration. However, this configuration is nothing more than a configuration which is utilized for verification for utilizing apparatuses having equivalent functions or capable of performing equivalent processing.

When giving attention to an actual general office environment for the situation in which such a configuration is proposed, it seems that there are situations in which it can not be necessarily said with certainty that the above-mentioned configuration matches the case. For example, it seems that in the general office environment, it is uncommon to possess a plurality of multifunction peripherals (hereinafter referred to as “MFP”) of the same type and MFPs having equivalent functions. For example, it is believed that it is uncommon to purchase two or more digital composition apparatuses having a plurality of functions including a copy function and a print function as one example of the MFP for the same office. Rather, it is believed that the case of possession of a plurality of apparatuses which are not apparatuses having same functions (same capacities), such as one digital composition apparatus and one SFP (single function peripheral) having only a print function is dominant over the case described above from a viewpoint of probability.

It is believed that there is a possibility that for such an environment, the above-mentioned configuration cannot efficiently exhibit its effect. In other words, there is a possibility that for the above-mentioned configuration, environments where its function and resource can be effectively used are quite limited.

Thus, in the environment where the above-mentioned print system can be provided, for example, the remote printing apparatus allowing a user to make a selection for carrying out cluster printing and alternative printing is limited to printing apparatuses having equivalent functions/equivalent processing. On the other hand, however, in the general office environment, for example, the environment where a very small number of MFPs (one or two MFPs) exist among a large number of single function peripherals (hereinafter referred to as “SFP”) or the environment where SFPs and MFPs having different functions coexist is dominant from a situational point of view.

Thus, it is conceivable that it is difficult to apply a technique regarding a print system having the above-mentioned configuration to a print system actually present in the general office environment. For example, it is conceivable that the above-mentioned print system cannot perform cluster printing and alternative printing among printing apparatuses having different functions or capacities. Accordingly, there are concerns that it is difficult to maintain high convenience of the system, and so on.

Thus, it can be said that there is much room for further consideration for making a close study of user's use environments to achieve cluster printing and alternative printing making maximum use of a resource available under the actual system environment.

### SUMMARY OF THE INVENTION

An object of the present invention is to provide a print system, a print control method, a job processing method, a local printing apparatus, a storage medium and a program capable of solving the problems described above.

An object of the present invention is to provide a print system, a print control method, a job processing method, a local printing apparatus, a storage medium and a program flexibly adapting to an apparatus use environment and allowing construction of a convenient environment capable of making maximum use of a resource even when processing, such as cluster printing, using a plurality of apparatuses is performed.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing one example of the configuration of a print system according to an embodiment of the present invention;

FIG. 2A is a block diagram showing one example of the configuration of an MFP 101;

FIG. 2B is a block diagram showing one example of the configuration of an SFP 105;

FIG. 3A is a block diagram showing one example of the configuration of hardware of a controller 201 of the MFP 101;

FIG. 3B is a block diagram showing one example of the configuration of hardware of a controller 211 of the SFP 105;

FIG. 4A is a block diagram showing one example of the configuration of software executed by a CPU 301 in the MFP 101;

FIG. 4B is a block diagram showing one example of the configuration of software executed by a CPU 311 in the SFP 105;

FIG. 5A is a flowchart corresponding to one example of processing in the MFP 101 corresponding to first and second embodiments of the present invention;

FIG. 5B is a flowchart corresponding to one example of processing in the MFP 101 corresponding to first and second embodiments of the present invention;

FIG. 6 shows one example of an initial setting screen corresponding to first and second embodiments of the present invention;

FIG. 7 shows one example of a printing apparatus list display screen corresponding to first and second embodiments of the present invention;

FIG. 8 shows one example of a clustering mode setting screen corresponding to first and second embodiments of the present invention;

FIG. 9 shows one example of a partner setting manual change screen corresponding to first and second embodiments of the present invention;

FIG. 10 shows one example of a cluster printing setting screen corresponding to first and second embodiments of the present invention;

FIG. 11 shows one example of function information corresponding to first and second embodiments of the present invention;

FIG. 12 is a view explaining an example of control of the embodiment;

FIG. 13 is a view explaining an example of control of the embodiment;

FIG. 14 is a view explaining an example of control of the embodiment;

FIG. 15 is a view explaining an example of control of the embodiment;

FIG. 16 is a view explaining an example of control of the embodiment;

FIG. 17 is a view explaining an example of control of the embodiment;

FIG. 18 is a view explaining an example of control of the embodiment;

FIG. 19 is a view explaining an example of control of the embodiment; and

FIG. 20 is a view explaining an example of control of the embodiment.

### DETAILED DESCRIPTION OF THE PREFERRED EMBODIMENTS

Preferred embodiments of the present invention will now be described in detail in accordance with the accompanying drawings.

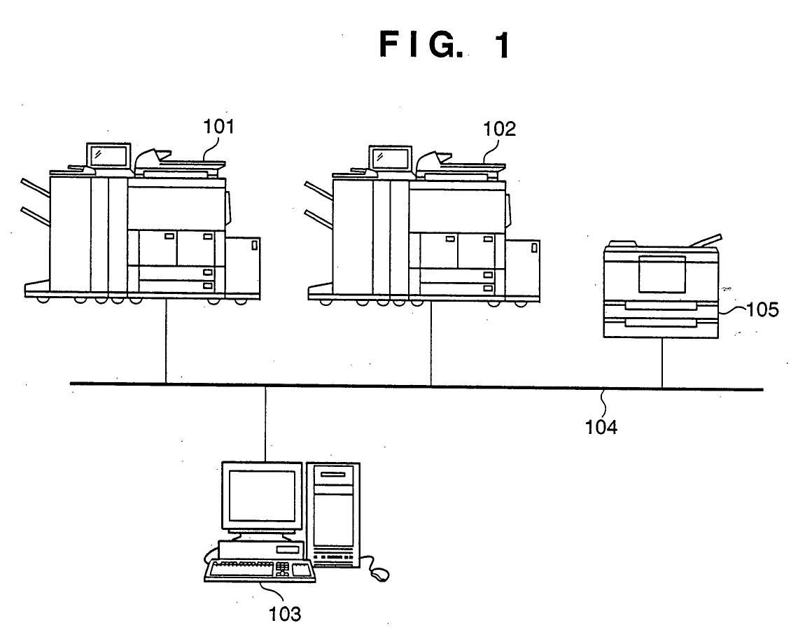

FIG. 1 shows the configuration of a print system according to an embodiment of the present invention. The print system in the present invention has a plurality of printing apparatuses. In this system, a job which can be printed by a printing apparatus used by a user can be distributed to other printing apparatuses to be processed, or processed by other printing apparatus substitutively.

A specific example of cluster printing of one example in which processing is distributed between a self apparatus and other printing apparatus and performed will now be described. In this embodiment, control is performed so that a cluster printing operation described below can be performed by the system.

For example, printing process of data of a job to be processed, which has been captured in an MFP 101, is performed by a printer unit 202 of the MFP 101 and performed by an MFP 102 and/or an SFP 105 corresponding to other printing apparatuses. Such cluster printing is also called distributed printing in this specification.

In this embodiment, the MFP 101 is called a master apparatus or local printer when distributed printing is performed with the MFP 101 as an input source of data of a job to be processed. Other printing apparatus as a distributed printing partner is called a slave apparatus or remote printer.

For example, when distributed printing is performed with the MFP 101 as a master apparatus, a control unit 201 of the MFP 101 stores data of a job to be processed, which has input from a scanner unit 202 or external apparatus, in a hard disk 304 of the MFP 101. One example of the external apparatus is a host computer or printing apparatus other than the MFP 101. The control unit 201 of the MFP 101 transfers the data of the job stored in the hard disk 304 to the printer unit 202 of the MPF 101, where the data is printed. At the same time, the data is transferred to other printing apparatus via a predetermined communication medium such as a network 104. In this way, printing process is performed by other printing apparatus in parallel with (concurrently with) printing process by the self apparatus. Such distributed printing with the MFP 101 as a master can be performed.

In this embodiment, distributed printing can be performed with a printing apparatus other than the MFP 101 as a master apparatus as a matter of course. For example, cluster printing can be performed with the MFP 102 as a master apparatus.

The MFP 102 is called a master apparatus or local printer when distributed printing is performed with the MFP 102 as an input source of data of a job to be processed. Other printing apparatus of the distributed printing partner is called a slave apparatus or remote printer.

When distributed printing is performed with the MFP 102 as a master apparatus, for example, a control unit of the MFP 102 stores data of a job to be processed, which has been input from a scanner unit of the self apparatus or an external apparatus, in a hard disk of the MFP 102. The external apparatus here means a host computer or printing apparatus other than the MFP 102. The control unit of the MFP 102 transfers the data of the job stored in the hard disk of the self apparatus to a printer unit of the MPF 102, where the data is printed. At the same time, the data is transferred to other printing apparatus via a predetermined data communication medium such as the network 104. In this way, printing process is performed by other printing apparatus in parallel with (concurrently with) printing process by the self apparatus. Such distributed printing with the MFP 102 as a master can be performed.

In this embodiment, cluster printing can be performed with a type of printing apparatus having no scanner unit, such as an SFP 105, as a master apparatus. For example, cluster printing can be performed with the SFP 105 as a master apparatus.

When distributed printing is performed with the SEP 105 as an input source of data of a job to be processed, the SFP 105 is called a master apparatus or local printer. Other printing apparatus of the distributed printing partner is called a slave apparatus or remote printer.

When cluster printing is performed with the SFP 105 as a master apparatus, for example, a control unit 211 of the SFP stores data of a job to be processed, which has been input from an external apparatus, in a hard disk 314 of the self apparatus. The external apparatus here is a host computer or printing apparatus other than the SFP 102. The control unit 211 of the SFP 105 transfers the data of the job stored in the hard disk 314 of the self apparatus to a printer unit 212 of the SFP 105, where the data is printed. At the same time, the data is transferred to other printing apparatus via a predetermined data communication medium such as the network 104. In this way, printing process is performed by other printing apparatus in parallel with (concurrently with) printing process by the self apparatus. In this way, distributed printing with the SFP 105 as a master apparatus can be performed.

The SFP 105 has no scanner unit. Therefore, when cluster printing is performed with the SFP 105 as a master apparatus, the data of the job input from the host computer or the scanner unit of the MFP is received by the SMP 105. The job data received from outside is stored in the hard disk 314. It is made possible to accept an instruction to perform cluster printing of the data of the job stored in the hard disk 314 from a user via a UI unit 214 of the SFP 105. It is made possible to perform cluster printing process with the SFP 105 operated as a master apparatus by the instruction.

In this embodiment, the cluster printing operation described above can be performed by the system of FIG. 1.

Operations of the cluster printing operation capable of being performed by the system configuration of FIG. 1 include, for example, at least operations listed below:

(1) distributed printing by two printing apparatuses, the MFP 101 and the MFP 102;

(2) distributed printing by two printing apparatuses, the MFP 101 and the SFP 105;

(3) distributed printing by two printing apparatuses, the MFP 102 and the SFP 105; and

(4) distributed printing by three printing apparatuses, the MFP 101 and the MFP 102 and the SFP 105.

It may be made possible to perform all the cluster printing operations of four patterns (1) to (4) described above. Alternatively, it may be made possible to perform at least any of the patterns. However, it is desirable that distributed printing of at least a pattern other than the pattern (1), such as the pattern (2) or (3) can be performed.

In other words, for example, not only a distributed printing operation by printing apparatuses having same functions and/or capable of performing equivalent processing as in the pattern (1) but also a distributed printing operation of the pattern (2) or (3) can be performed.

Namely, cluster printing can be performed by printing apparatuses which are not printing apparatuses having same functions and/or capable of performing equivalent processing. For example, in this embodiment, control is performed so that performance of a distributed printing operation using a plurality of printing apparatuses of different types and different series is not prohibited but permitted.

For one example of a data input source inputting image data of a job to be processed when the cluster printing operation is performed by the system of FIG. (1), at least any of the following data input units can be used: (1) scanner of the MFP 101, (2) scanner of the MPF 102 and (3) host computer 103.

For one example of a user interface unit (hereinafter referred to as UI in this embodiment) for making it possible to input various kinds of instructions including an instruction to perform cluster printing, at least any of the following UIs can be used: (1) display apparatus capable of displaying a printer driver screen for printing apparatuses 101, 102 and 105 and the like of this embodiment, and a keyboard and a pointing device such as a mouse, which are possessed by the host computer 103, (2) operation unit of the MFP 101, (3) operation unit of the MFP 102 and (4) operation unit of the SFP 105.

In cluster printing, a series of printing operations are shared by a plurality of printing apparatuses, but in this embodiment, at least one job can be printed distributively with the number of copies as a unit, and printed distributively by any of the following two distribution methods: (1) equal allocation method and (2) capacity allocation method.

For instance, an instruction to print 100 copies of document data consisting of 5 pages is input by a user via the UI of the MFP 101. Namely, as one of processing conditions for processing a job to be processed, the number of copies set by the user via the UI is 100. In addition, an instruction to perform cluster printing using two printing apparatuses, the MFP 101 and the MFP 102 is input by the user via the UI of the MFP 101.

An example of control where the job having the above-mentioned processing conditions is subjected to cluster printing by (1) equal allocation method will be described. When document data of the job of which the total number of print copies is 100 is subjected to distributed printing by equal allocation, for example, the control unit 201 of the MFP 101 as a master apparatus equally allocates the number of print copies to the MFP 101 and the MFP 102.

Namely, in this example, a calculation process of 100 (copies)÷2 (units)=50 (copies) is applied. The MFP 101 is made to perform printing process of 50 copies of the document consisting of 5 pages. At the same time, in parallel with (concurrent with) this operation, the MFP 102 is made to perform printing process of the remaining number of copies, i.e. 50 copies of the document consisting of 5 pages. Such distributed printing can be performed by equal allocation.

An example of control where the job having the above-mentioned processing conditions is subjected to cluster printing by (2) capacity allocation method will now be described.

When document data of the job of which the total number of print copies is 100 is subjected to distributed printing by capacity allocation, for example, the control unit 201 of the MFP 101 as a master apparatus allocates the number of print copies to the MFP 101 and the MFP 102 according to the printing speed.

For instance, the MFP 101 is a printing apparatus capable of printing 60 sheets per minute at the maximum. The MFP 102 is a printing apparatus capable of printing 40 sheets per minute at the maximum. Namely, the difference in speed is 3:2. The control unit 201 of the MFP 101 as a master apparatus allocates 60 (copies) determined by the calculation of 100 (copies)÷(60 (sheets)÷(60 (sheets)+40 (sheets)) as the number of copies allocated for the MFP 101. 40 (copies) determined by the calculation of 100 (copies)÷(40 (sheets)÷(60 (sheets)+40 (sheets)) is allocated as the number of copies allocated for the MFP 102.

Through such allocation calculation, the MFP 101 is made to perform printing process of 60 copies of the document consisting of 5 pages. At the same time, in parallel with (concurrently with) this operation, the MFP 102 is made to perform printing process of the remaining number of copies, i.e. 40 copies of the document consisting of 5 pages. Such distributed printing can be performed by capacity allocation.

It may be made possible to perform distributed printing by any of the above-mentioned two allocation methods, but it is desirable that main control such as processing of allocation calculation of the number of print copies should be performed by the control unit 201 of the MFP 101 as a master apparatus.

In this embodiment, processing of allocation of the allocated number of copies to each printing apparatus is performed by the control unit based on the total number of print copies input via the UI by the user as described above. Namely, in the above-mentioned example, the user should only set 100 copies, the number corresponding to the total number of print copies, via the UI. In other words, it is not necessary to input by the user the value itself of the allocated number of copies, such as “perform distributed printing with the total number of copies split into 50 copies and 50 copies” or “perform distributed printing with the total number of copies split into 60 copies and 40 copies”. In this embodiment, distributed printing can be performed based on the total number of print copies input by the user without directly specifying the allocated number of copies by the user.

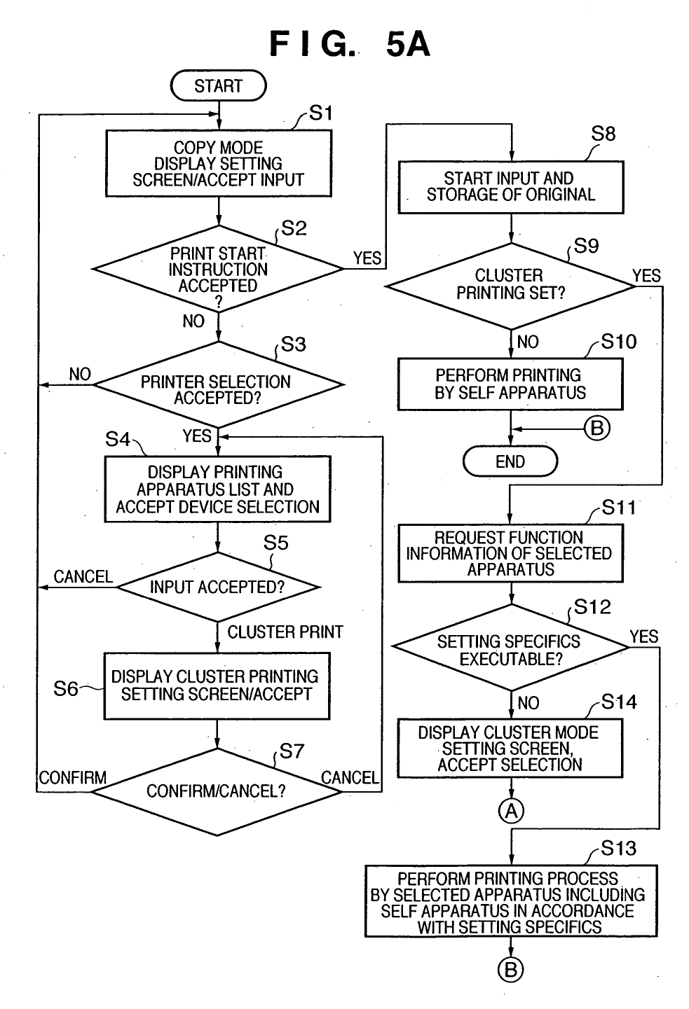

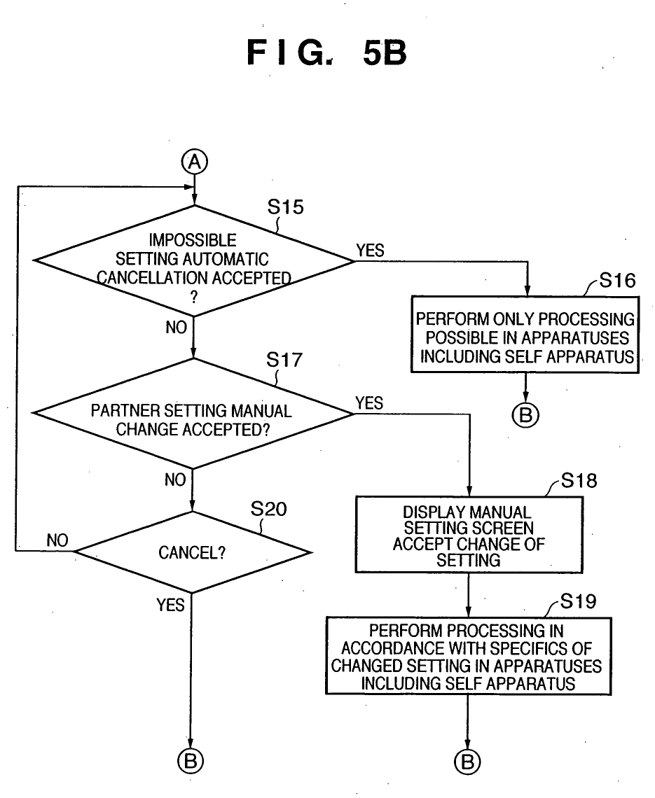

As shown in FIG. 1, the print system of this embodiment is constructed by connecting a plurality of multifunction peripherals (MFP) 101 and 102, the client PC (information processing apparatus) 103 and the single function printing apparatus (SFP) 105 such as a printer via the network 104. Consequently, each MFP can exchange data with the other MFP, the client PC and the SFP via the network 104, and perform processing described later with reference to FIGS. 5A and 5B and subsequent figures regarding printing in the system.

The MFPs 101 and 102 may have a copy function, a scanner function, a telephone/facsimile function and the like in addition to a print function. The SFP 105 has only a print function. The MFPs 101 and 102 and the SFP 105 can serve as a local printing apparatus of the present invention or other printing apparatus performing alternative printing. The printing apparatus of the present invention may be in the form of a multifunction peripherals, or may have at least a print function such as a printer or copier, and should only have at least a predetermined user interface in addition to the print function. The other printing apparatus performing alternative printing has at least a print function. The client PC 103 may be a general computer such as a personal computer.

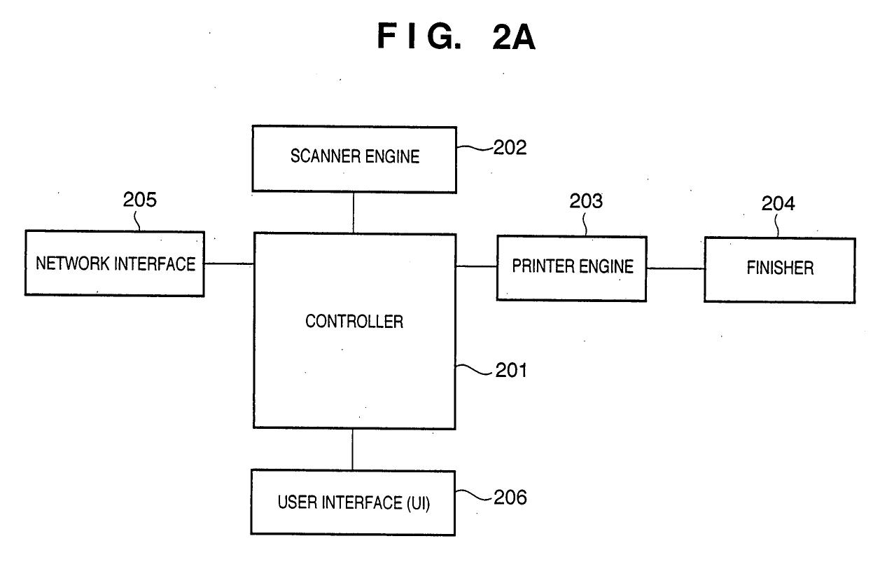

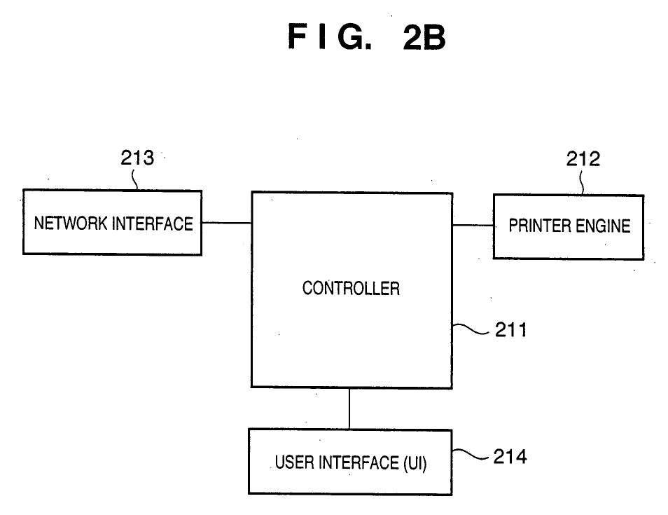

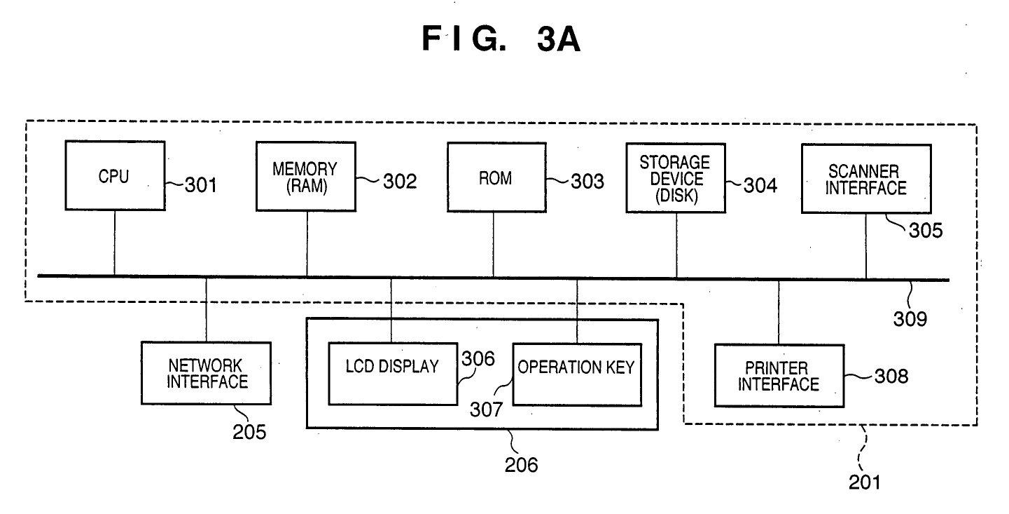

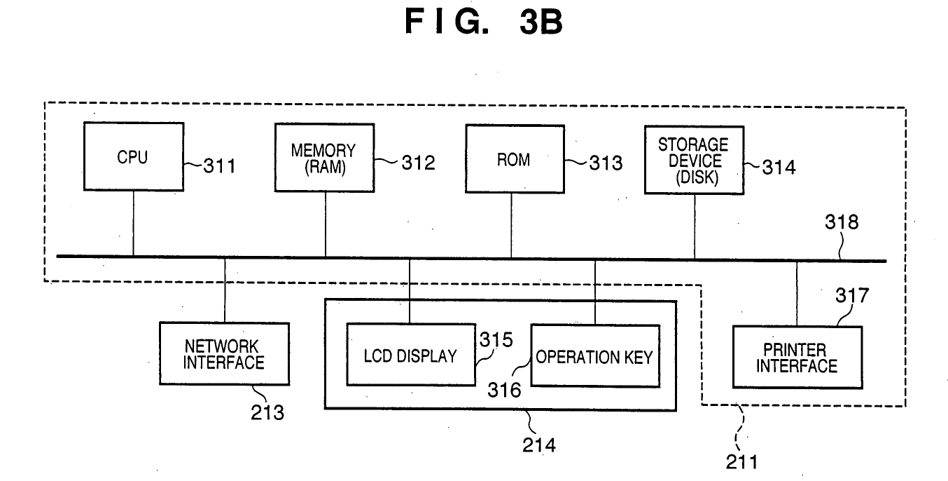

FIG. 2A is a block diagram showing the configuration of the MFP 101 shown in FIG. 1. The MFP 101 has a print function, a copy function and a scanner function. In FIG. 2A, the controller 201 controls each element constituting the MFP 101, and has a hardware configuration described later with FIGS. 3A and 3B. A scanner engine 202 comprises a CCD sensor, an optical system guiding light illuminating an original to the CCD sensor, and the like, and carries out an operation of optically reading an original image under control of the controller 201. A printer engine 203 comprises an electrophotographic method by a laser beam, and prints an image on a printing medium based on print data under control of the controller 201. A finisher 204 is connected to the printer engine 203, and carries out processing of collectively stapling a plurality of printing media (e.g. printing sheets) print-output from the printer engine 203 under control of the controller 201.

A network (e.g. Ethernet®) interface 205 enables two-way communication between the controller 201 and the client PC 103 and MFP 102 connected via the network 104 shown in FIG. 1. Consequently, for example, if the main MFP 101 is a local printing apparatus, a print job can be transferred to other printing apparatus connected via the network 104. Conversely, if the main MFP 101 is specified as other printing apparatus performing alternative printing, a print job is sent from other local printing apparatus, and printing based on the print job can be performed.

In addition, if an inquiry is made to a general control manager (supervisor) via the interface 105 from other apparatus connected via the network 104, the other apparatus can acquire functions provided by the main MFP 101, i.e. a print speed, double side printing, the type of finisher, a PDL supported, the number of output BINs that can be specified, a sheet feeding cassette, existence/nonexistence of a mounted hard disk, a sorting function and the like. The general control manager will be described later.

The user interface (UI) 206 comprises an LCD display 306 and an operation key 307 in the form of a touch panel, and displays various kinds of information and accepts an input under control by the controller 201. As described later with reference to FIGS. 5A and 5B and subsequent figures, in processing in the MFP 101 related to printing, guidance on operations related to printing is displayed on the LCD display 306 for the user, and an instruction to operate buttons on the display by user's operation of operation keys is conveyed to the controller 201.

FIG. 2B is a block diagram showing the configuration of the SFP 105 shown in FIG. 1. In this embodiment, the case where the SFP 101 is a printer having a print function will be described. In FIG. 2B, the controller 211 controls each element constituting the SFP 105, and has a hardware configuration described later with FIG. 3B. A printer engine 212 comprises an electrophotographic method by a laser beam, and prints an image on a printing medium based on print data under control of the controller 211.

A network interface 212 enables two-way communication between the controller 211 and the client PC 103 and MFP 101 connected via the network 104 shown in FIG. 1. Consequently, for example, if the SFP 105 is specified as a remote printing apparatus, a print job is sent from the MFP 101 connected via the network 104, and the SFP 105 can operate as a remote printing apparatus performing printing based on the print job.

If an inquiry regarding functions possessed by the SFP 105, and the like, is made via the network 104 from the MFP 101 connected via the network 104, the MFP 101 is notified of functions possessed by the SFP 105 (function information such as the printing speed, the size of a printing sheet and a double side printing function). The user interface (UI) 214 comprises a display and an operation key, and displays various kinds of information and accepts an input under control by the controller 211.

FIG. 3A is a block diagram showing the configuration of hardware of the controller 201 shown in FIG. 2A.

As shown in FIG. 3A, the controller 201 comprises a CPU 301, a memory (RAM) 302, a ROM 303, a storage device (DISK) 304, a scanner interface 305 and a printer interface 308, and these elements can be connected via a system bus 309 to mutually exchange data or signals. The LCD display 306 and the keyboard 307 constituting the user interface (UI) 206 shown in FIG. 2A, and the network interface 205 are connected to the system bus 309.

The storage device (DISK) 304 is in the form of a hard disk, floppy® disk or the like, and stores various kinds of programs and data, and these programs and data are read out by the CPU 301 as required, and thereby used. Various kinds of programs and data may be downloaded from the client PC 103 or other computer via the network 104 to the memory (RAM) 302 and used.

The display 306 and the operation key 307 in the form of a touch panel constitute the user interface (UI) 206 shown in FIG. 2A as an operation panel, and the CPU 301 writes data onto the display RAM of the display 306, whereby display is provided, and an input of an instruction by the user from the operation key 307 is accepted.

The network interface 205 connected to the system bus 309 reads or writes data or signals transferred via the network interface 205 when the CPU 301 communicates with the network 104 shown in FIG. 1.

Further, the scanner interface 305 and the printer interface 308 are connected to the system bus 309, they each exchange data with the scanner engine 202 and the printer engine 203 shown in FIG. 2A, and the CPU 301 reads and writes data or signals to these engines, whereby an engine operation such as scanning, printing or the like is performed and various kinds of statuses are acquired. These engines may exist not in the apparatus of the MFP but on the network 104 each as a single peripherals, and they may be controlled by the controller 201.

FIG. 3B is a block diagram showing the configuration of hardware of the controller 211 shown in FIG. 2B.

As shown in FIG. 3B, the controller 211 comprises a CPU 311, a memory (RAM) 312, a ROM 313, a storage device (DISK) 314 and a printer interface 317, and these elements can be connected via a system bus 318 to mutually exchange data or signals. An LCD display 315 and a keyboard 316 constituting the user interface (UI) 214 shown in FIG. 2B, and a network interface 213 are connected to the system bus 318.

The storage device (DISK) 314 is in the form of a hard disk, floppy® disk or the like, and stores various kinds of programs and data, and these programs and data are read out by the CPU 311 as required, and thereby used. Various kinds of programs and data may be downloaded from the client PC 103 or other computer via the network 104 to the memory (RAM) 312 and used.

The display 315 and the operation key 316 constitute the user interface (UI) 214 shown in FIG. 2B as an operation panel, and the CPU 311 writs data onto the display RAM of the display 315, whereby display is provided, and an input of an instruction by the user from the operation key 316 is accepted.

The network interface 213 connected to the system bus 318 reads or writes data or signals transferred via the network interface 213 when the CPU 311 communicates with the network 104 shown in FIG. 1.

Further, the printer interface 317 is connected to the system bus 318, they each exchange data with the printer engine 212 shown in FIG. 2B, and the CPU 311 reads and writes data or signals to these engines, whereby a printer engine operation is performed and various kinds of statuses are acquired.

The configuration of software (program module) stored in the storage device (DISK) 304 in the controller 201 of the MFP 101, loaded into the memory (RAM) 302 as required, and accordingly executed by the CPU 301 will now be described.

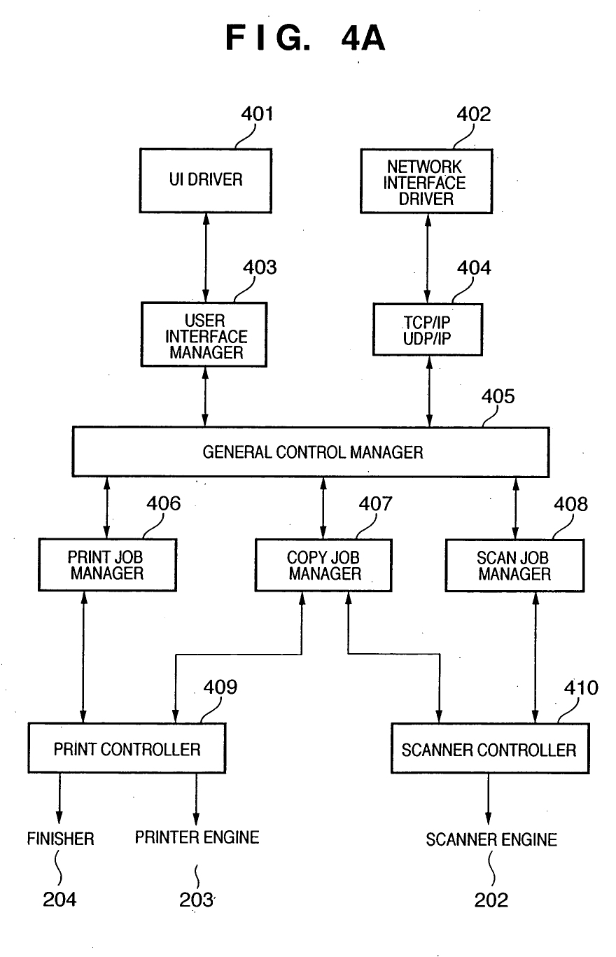

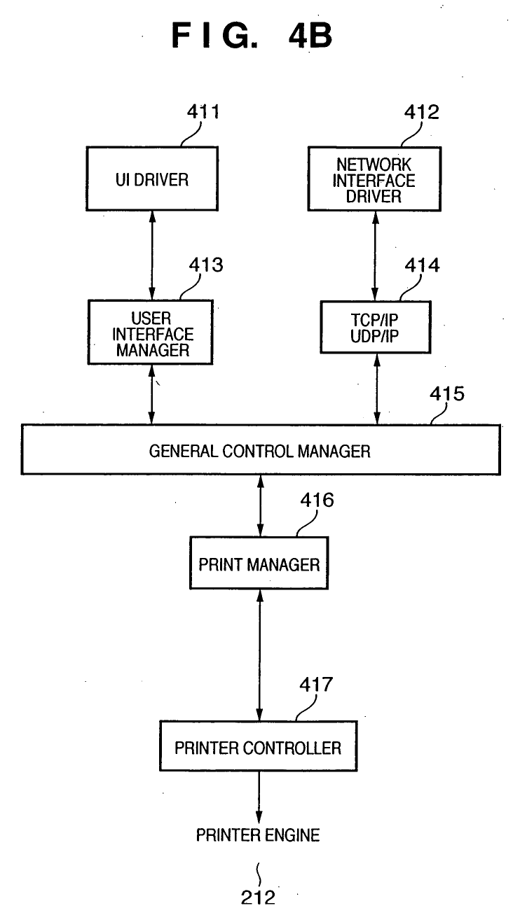

FIG. 4A is a block diagram showing the configuration of software executed by the CPU 301 in the MFP 101 described above.

In FIG. 4A, reference numeral 401 denotes a user interface (UI) driver, by which the CPU 301 controls the LCD display 306 and the operation key 307 shown in FIG. 3A. Reference numeral 403 denotes a user interface manager (control program), by which the CPU 301 obtains from the UI driver 401 input information input by the user via the display 306 and the operation key 307, conveys the input information to a general control manager (supervisor) 405 supervising the operation of the controller 201 in its entirety, obtains the result of processing by the controller 201 via the general control manager 405, and instructs the UI driver 401 to display the result on the display 306.

Reference numeral 402 denotes a network interface driver (control program), by which the CPU 301 controls the network interface 205, and performs processing of a physical layer (physical packet) in the network, i.e. extraction of a transport packet from the physical packet and generation of the physical packet from the transport packet.

Reference numeral 404 denotes a communication module such as TCP/IP or UDP/IP, by which the CPU 301 conveys information of a transport packet output from the network interface driver 402 to the general control manager 405. A transport packet is generated from information of the general control manager 405, and output to the network interface 205 via the network interface driver 402.

Reference numeral 405 denotes the general control manager (supervisor) for supervising performance of processing of the controller 201 in its entirety. The CPU 301 detects a function and a status in the MFP 101 by executing the general control manager 405, and holds the detected function and status in the storage device 304 as function information of the apparatus. More specifically, an instruction to make a reference to and change data such as processing capacities held by a print job manager 406, a copy manager 407 and a scan job manager 408 is provided, generated jobs (print job, copy job and scan job) are delivered to the managers, and the status is monitored.

The general control manager 405 further has a function of receiving a command indicating that function information in the MPF 101 is requested via the network interface 205 and the network interface driver 402, and a function of sending function information of the self apparatus back to a sender of the command in response to the received command.

Reference numeral 406 denotes the print job manager, by which the CPU 301 controls management of a printer resource and performance of a job. Reference numeral 409 denotes a printer controller, by which the CPU 301 operates the printer engine 203 in response to a request from the print job manager 406. Reference numeral 407 denotes the copy manager, by which the CPU 301 manages a copy resource and a copy job. Reference numeral 408 denotes the scanner job manager, by which the CPU 301 controls management of a scanner resource and performance of a job. Reference numeral 410 denotes a scanner controller, by which the CPU 301 operates the scanner engine 202 in response to a request from the scanner job manager 408.

The configuration of software (program module) stored in the storage device (DISK) 314 in the controller 211 of the SFP 105, loaded into the memory (RAM) 312 as required, and accordingly executed by the CPU 311 will be described.

FIG. 4B is a block diagram showing the configuration of software executed by the CPU 311 in the SFP 105. In FIG. 4B, reference numeral 411 denotes a user interface (UI) driver, by which the CPU 311 controls the LCD display 315 and the operation key 316 shown in FIG. 3B. Reference numeral 413 denotes a user interface manager (control program), by which the CPU 311 obtains from the UI driver 411 input information input by the user via the display 315 and the operation key 316, conveys the input information to a general control manager (supervisor) 415 supervising the operation of the controller 211 in its entirety, obtains the result of processing by the controller 211 via the general control manager 415, and instructs the UI driver 411 to display the result on the display 315.

Reference numeral 412 denotes a network interface driver (control program), by which the CPU 311 controls the network interface 213, and performs processing of a physical layer (physical packet) in the network, i.e. extraction of a transport packet from the physical packet and generation of the physical packet from the transport packet.

Reference numeral 414 denotes a communication module such as TCP/IP or UDP/IP, by which the CPU 311 conveys information of a transport packet output from the network interface driver 412 to the general control manager 415. A transport packet is generated from information of the general control manager 415, and output to the network interface 213 via the network interface driver 412.

Reference numeral 415 denotes the general control manager (supervisor) for supervising performance of processing of the controller 211 in its entirety. The CPU 311 detects a function and a status in the SFP 105 by executing the general control manager 415, and holds the detected function and status in the storage device 314 as function information of the apparatus. More specifically, an instruction to make a reference to and change data such as a processing capacity held by a print job manager 416 is provided, a print job is delivered to the print job manager 416, and the status is monitored.

The general control manager 415 further has a function of receiving a command indicating that function information in the SFF 105 is requested via the network interface 213 and the network interface driver 412, and a function of sending function information of the self apparatus back to a sender of the command in response to the received command.

Reference numeral 416 denotes the print job manager, by which the CPU 311 controls management of a printer resource and performance of a job. Reference numeral 417 denotes a printer controller, by which the CPU 311 operates the printer engine 212 in response to a request from the print job manager 416.

Some embodiments of printing process by the print system described above and the MFP and the SFP as printing apparatuses constituting the print system will be described below.

### First Embodiment

FIG. 5A and FIG. 5B are a flowchart showing processing during a copy operation by cluster printing in the MFP 101 according to the first embodiment of the present invention. In this example, the MFP 101 is used as a local printing apparatus (master apparatus). Other apparatus such as the MEP 102 and the SFP 105 connected to the network 104 is used as a printing apparatus (slave apparatus) capable of performing cluster printing. The flow of processing in this case is a flow of processing performed principally by the control unit 201 (also referred to as controller 201) of the MFP 101. A series of printing process performed distributively by a local printing apparatus and a remote printing apparatus will be described as one example of cluster printing.

Even if for example, the MFP, a printer on the network, or the like operates as a printing apparatus under control of the client PC, the printing apparatus can be applied as a printing apparatus called a local printing apparatus in this application. That is, the local printing apparatus is not limited to an apparatus which can directly accept an operation related to printing from the user at a location where the printing apparatus is installed. Irrespective of whether or not the user is present at a location where the apparatus is installed, the apparatus to which the user first provides an instruction of printing operation with the intention of use in printing is the local printing apparatus.

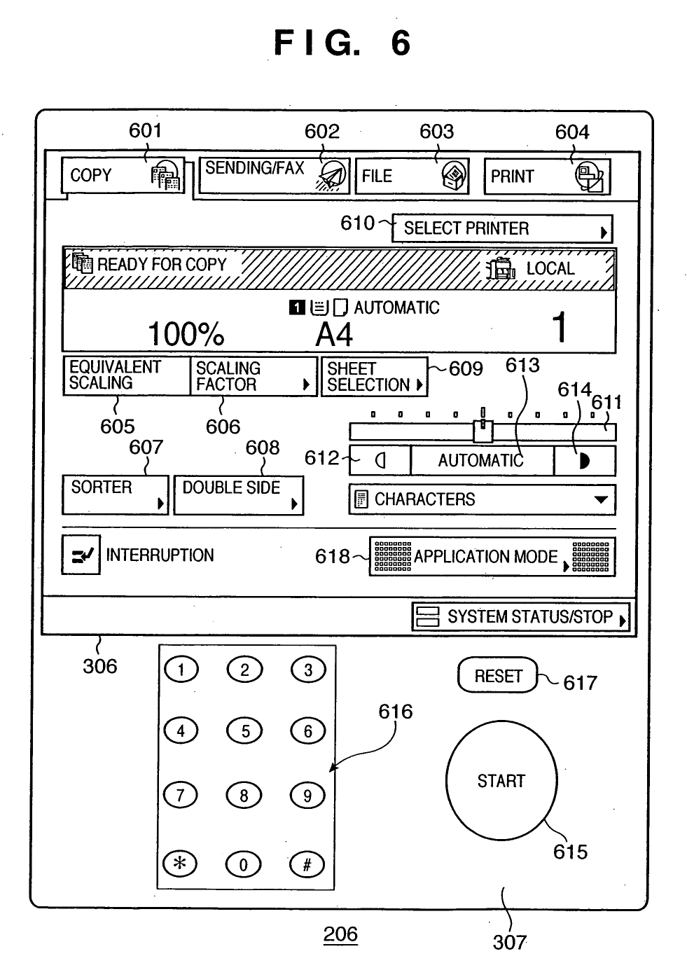

At step S1 of the flowchart shown in FIG. 5A, the controller 201 of the MFP 101 displays a setting screen of FIG. 6 on the LCD display 306 of the MFP 101 as one example of the UI. The state in FIG. 6 is a state in which the MFP 101 is on standby for printing (state in which a job is not processed at all). In the step, the control unit 201 makes it possible to accept an input of copy mode setting from the user via the screen of FIG. 6.

The controller 201 controls the user interface (hereinafter referred to as UI) 206 in response to acceptance of a copy mode setting operation from the user. In addition, the UI 206 is controlled so that the user can be notified of guidance information of “ready for copy” and the like as shown in FIG. 6. In this stage, for example, an original bundle to be processed is set on a reading apparatus (e.g. ADF) of a scanner by the user.

The display unit 306 in FIG. 6 comprises soft keys such as, for example, keys 605 to 614, corresponding to items capable of being set by the user. The UI 206 comprises hard keys such as keys 615 to 617 in addition to such soft keys of the UI in the form of a touch panel.

An equivalent scaling key 605 is a key for making it possible to input by the user an instruction for printing original data input to the MFP 101 with a scaling factor of 100%. A scaling key 606 is a key for making it possible to input by the user an instruction for printing input original data with the scaling factor changed to a scaling factor other than the equivalent scaling factor, e.g. with the original data scaled down or scaled up.

A sheet selecting key 609 is a key for making it possible to select by the user a sheet to be used in printing process of a job to be processed.

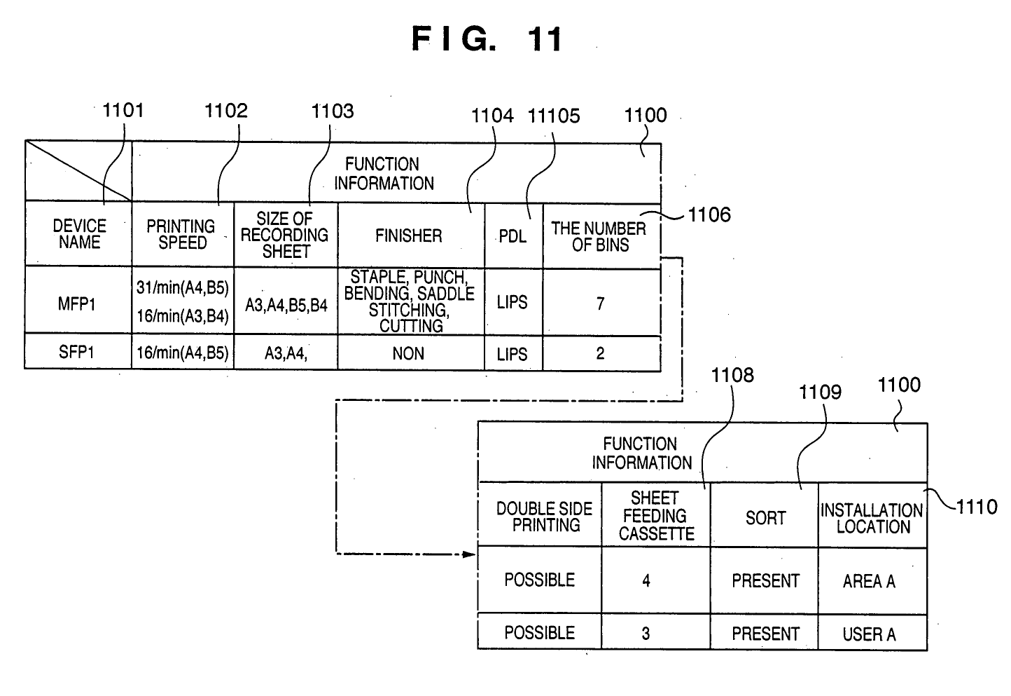

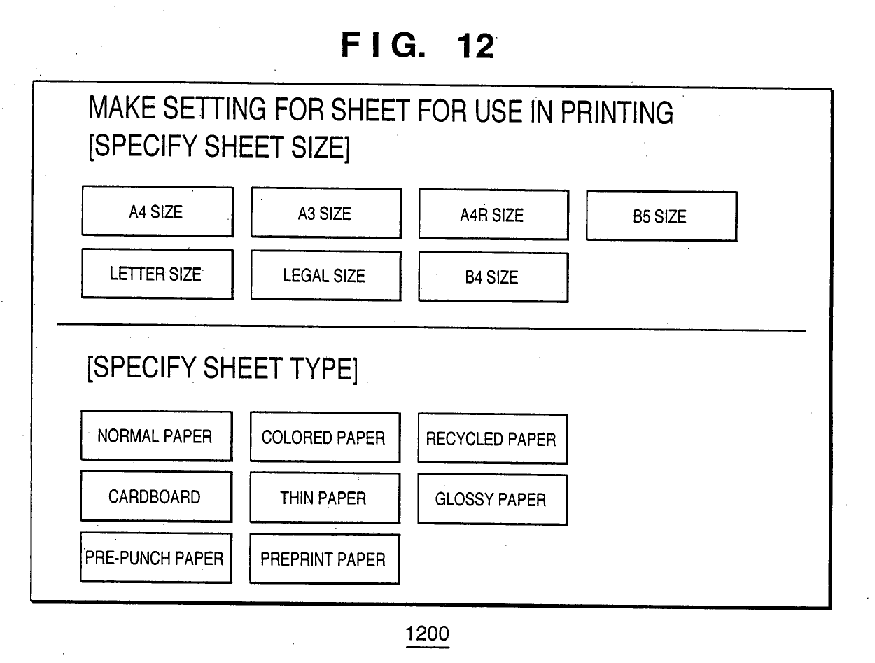

For example, the control unit 201 displays a screen 1200 of FIG. 12 on the display unit 306 in response to the key 609 being pressed down by the user. Setting regarding a sheet to be used by the apparatus in printing process of a job to be processed can be accepted from the user via the screen 1200. For example, the user can specify the size and type of sheet via the screen 1200. In the screen 1200, available candidates are presented by the user. However, it is preferable that the user can determine a desired candidate from selectable candidates set on a sheet feeding unit of the self apparatus, i.e. the MFP 101 in this example, and capable of being used in printing process. That is, control is performed so that items corresponding to sheets not set on the MFP 101 are not selectable. For example, item buttons for setting of sheets which cannot be selected by the user are displayed in gray-out or displayed in halftone. Alternatively, control is performed so that the button themselves are not displayed. In this way, control is performed so that setting of sheets which cannot be used in printing process in the MFP 101 cannot be performed by the user. The control unit 201 makes it possible to control the display of item buttons on the screen 1200 based on sheet residual quantity information from a sensor of the sheet feeding unit of the MFP 101, and initial setting information. Information of a management table of FIG. 11 described later or the like can be used.

A sorter key 607 is a key for making it possible to specify by the user what type of sheet processing (also referred to as post-processing) is performed by a finisher for a sheet on which a job to be processed is printed.

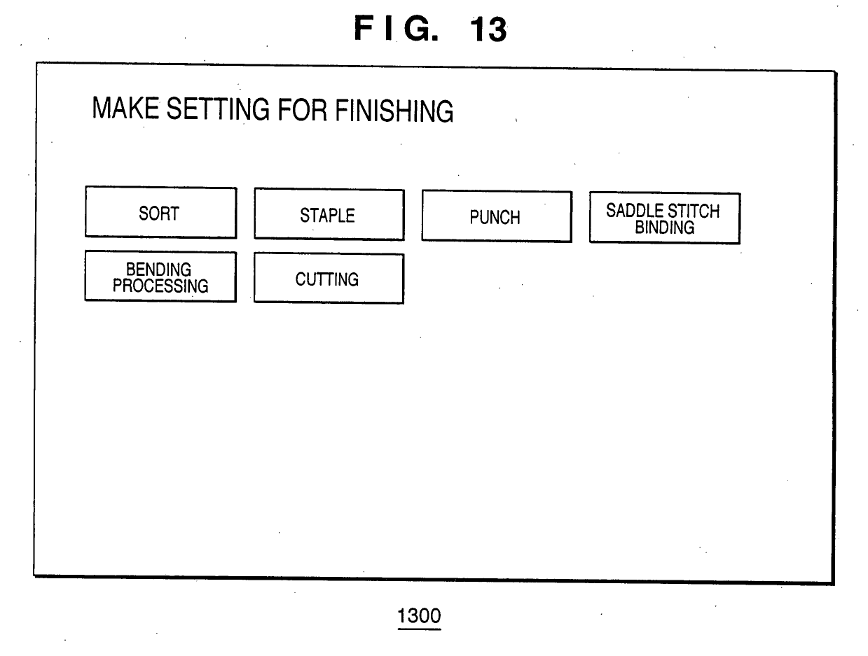

For example, the control unit 201 displays a screen 1300 of FIG. 13 on the display unit 306 in response to the key 607 being pressed down by the user. Setting for the type of sheet processing to be performed for a sheet on which a job to be processed has been printed can be accepted via the screen 1300 from the user. For example, the user can determine desired sheet processing from a plurality of candidates such as sort, staple, punch, cutting and saddle stitch binding via the screen 1300. On the screen 1300, candidates of sheet processing which can be performed by the finisher of the MFP 101 are presented by the user. Control is performed so that items which cannot be performed by the finisher of the MFP 101 are not selectable. For example, buttons are displayed in gray-out or displayed in halftone to perform control so that sheet processing which cannot be performed by the MFP 101 is prohibited from being accepted from the user. The control unit 201 makes it possible to control the display of item buttons on the screen 1300, and information of a management table of FIG. 11 described later or the like can be used.

A double side key 608 is a key for making it possible to make a selection on whether data of a job to be processed is printed by single side printing or double side printing by the user.

For density keys 612 and 614, the copy density is set to be lower each time the key 612 is pressed down, and the copy density is set to be higher each time the key 614 is pressed down. A density indication 611 is displayed while shifting from side to side when the density key is pressed. An A key 613 is a key which is pressed when an original having a high background density, such as a newspaper, is copied in an automatic density adjustment mode. When each key is selected, a corresponding setting screen is displayed, and setting can be accepted. An application mode key 618 is a key making it possible to set by the user an application processing mode, such as setting for reduced layout and page number print setting, for a job to be processed.

A key 610 on a screen of FIG. 6 displayed on the display unit 306 by the controller 201 is a printer selection key. This key is used when the user inputs an instruction to perform alternative printing such as remote copying as printing process of a series of image data of a job to be processed, which has been captured in the MFP 101. The key is also a key which is used when the user inputs an instruction to perform cluster printing such as double-serial copying. The key is also a key which is used when the user specifies a printing apparatus to be used among a plurality of apparatuses existing in the system for performing printing process by other printing apparatus as this cribbed above.

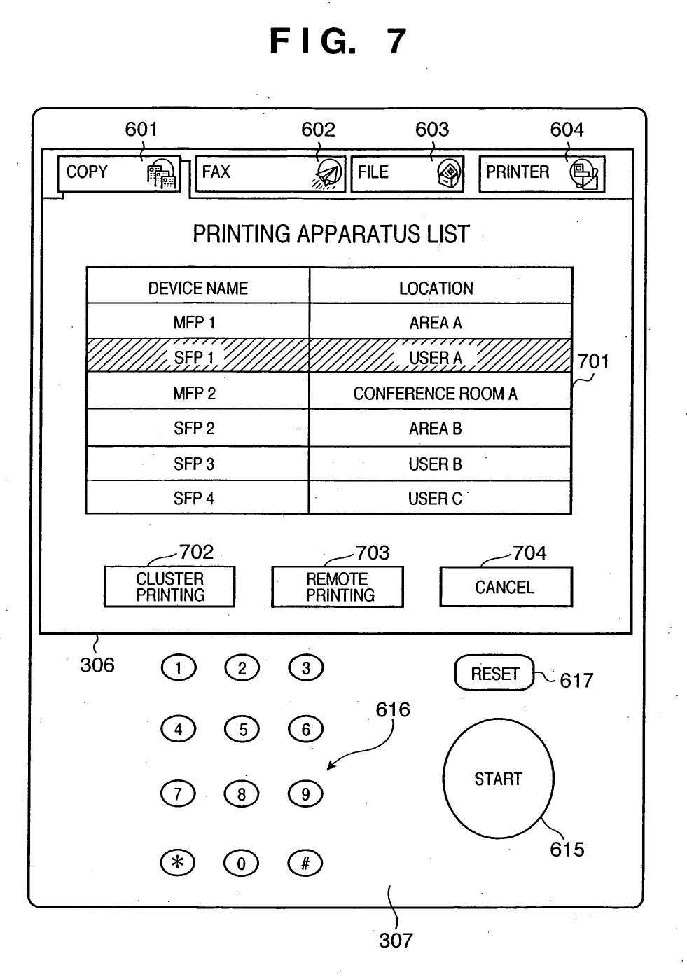

For example, the control unit 201 displays a screen shown in FIG. 7 on the display unit 306 in response to the printer selection key 610 being pressed down.

The control unit 201 performs control so that one or more printing apparatuses to be used in printing process of a job to be processed can be selected from a plurality of printing apparatuses including the self apparatus and other apparatuses via a list 701 of the screen of FIG. 7 by the user. For example, the control unit 201 makes it possible to input an instruction to perform distributed printing by the selected printing apparatuses via a key 702 on the screen by the user after the printing apparatuses to be used are selected via the list 701 of FIG. 7 by the user.

If only one printing apparatus to be used is selected via the list 701 by the user, the control unit 201 determines that the processing is remote printing. In this example, printing image data captured by the MFP 101 using other one printing apparatus corresponds to the remote printing. If such remote printing (also referred to as alternative printing in this example), the control unit 201 makes it possible to accept an instruction to perform the operation from the user via a key 703.

When a cancel key 704 is pressed down, control is performed so as to return to the screen of FIG. 6.

An operation key group 307 comprises a start key 615 for accepting an instruction to start set processing, a ten key 616 for accepting an input of a numerical value, and a reset key 617 for accepting reset of set specifics.

The MFP 101 is configured to be capable of selecting and executing not only a copy mode but also other operation modes.

For example, when a facsimile key 602 on the screen of FIG. 6 is pressed down by the user, the control unit 201 makes it possible to perform processing of sending original data captured in the MFP 101 for external apparatuses such as the host computer 101 and other printing apparatuses.

When a file key 603 on the screen of FIG. 6 is pressed down by the user, original data of a job scanned by the scanner unit 202 can be stored in the storage device 314 of the MFP 101. This file function is also called a box function. The function can store not only jobs from the scanner 202 but also image data from the external apparatus such as the host computer in the storage device 314 in the bitmap form. When the function is selected by the user by pressing down the file key 603 in the UI, printing process of original data stored in the storage device 314 can be performed, and the original data stored in the storage device 314 can be sent to the external apparatus, based on an instruction from the user.

A printer key 604 is used when it is desired to change the print density, make a reference to the print output result of PLD data from the remote host computer, and so on. When the key 604 is pressed down, a job status list screen making it possible to notify the user of the job status of a job being performed or a job on standby for printing, which is to be processed by the MFP 101, can be displayed on the display unit 306.

As described above, the MFP 101 has a plurality of functions, and is configured to make it possible to select and execute a function appropriate to each application by the user. The MFP 102 has functions similar to those of the MFP 101.

At step S2, whether or not an instruction to start printing has been accepted from the user by pressing down a start key 615 of the operation key 307 is determined. If it is determined that the instruction to start printing has not been accepted, processing proceeds to step S3. If the instruction has been accepted, processing proceeds to processing in step S8.

At step S3, whether or not the printer selection key 610 on the screen shown in FIG. 6 has been selected by the user is determined. If the key 610 has been selected by the user, processing proceeds to step S4. At step S4, the control unit 201 displays the setting screen shown in FIG. 7 on the display unit 306 in response to the key 610 being pressed down. The screen of FIG. 7 comprises as a display component a list of printing apparatuses capable of performing cluster printing and substituent printing (remote printing). The control unit 201 makes it possible to accept selection of a printing apparatus and any of an instruction to perform cluster printing and an instruction to perform alternative printing from the user via the screen of FIG. 7.

The control unit 201 performs display control so that a list 701 on a display screen of FIG. 7 has displayed specifics representing the names of apparatuses selectable by the user and the installation locations of the apparatuses.

In this embodiment, a printing apparatus displayed on the uppermost part of the list 701 of FIG. 7 and having a apparatus name of MFP 1 corresponds to the MFP 101 itself, i.e. the self apparatus. The second apparatus (SFP 1 in FIG. 7) and subsequent apparatuses in the list 701 refer to other printing apparatuses. A printing apparatus displayed on the second part of the list and having a name of SFP 1 corresponds to the SFP 105 in FIG. 1. A printing apparatus displayed on the third part of the list and having a name of MFP 2 corresponds to the MFP 102 in FIG. 1.

In this embodiment, the user touches a corresponding item on the list 701, whereby a printing apparatus performing cluster printing or alternative printing can be selected by the user.

When no printing apparatus is selected by the user in the list 701, the control unit 201 changes the display state of the cluster print key 702 and the remote print key 703 to gray-out display. Namely, the control unit 201 makes it impossible to press down these keys by the user. In this way, the control unit 201 prohibits inputs by the user of an instruction to perform cluster printing and an instruction to perform remote printing when no printing apparatus is selected by the user.

The control unit 201 brings the remote print key 703 into an effective display state when at least only one printing apparatus other than the self apparatus is selected by the user in the list 701. In this way, the control unit 201 permits remote printing to be performed. The key 703 in an effective display state is pressed down by the user. In response thereto, for example, the control unit 201 prohibits printing process of image data of a job scanned by the self apparatus from being performed by the self apparatus. At the same time, the control unit 201 performs control so that the printing process is performed by other one printing apparatus selected via the list 701.

The control unit 201 brings the cluster print key 702 into an effective display state, when, for example, at least two printing apparatuses including the self apparatus and other printing apparatus are selected by the user. In this way, the control unit 201 permits cluster printing to be performed. The key 702 in an effective display state is pressed down by the user. In response thereto, for example, the control unit 201 performs control so that printing process of image data of a job scanned by the self apparatus shared and performed by a plurality of printing apparatuses selected by the user in the list 701, including two apparatuses, i.e. the self apparatus and other printing apparatus.

As cluster printing, for example, it may be made possible to accept selection of one or more printing apparatuses including the self apparatus. As alternative printing, it may be made possible to accept selection of one or more printing apparatuses excluding the self apparatus. In other words, this embodiment may have configuration in which distributed printing is performed using two printing apparatuses in total as distributed printing. This embodiment may have a configuration in which distributed printing can be performed using three or more printing apparatuses. However, in any configurations, it is preferable that distributed printing process can be performed using a plurality of printing apparatuses including two printing apparatuses, i.e. the self apparatus and other printing apparatus as printing process of data of a job to be processed. It is preferable that a mechanism giving consideration to needs of the user and use environments can be provided.

At step S5, the control unit 201 determines whether or not a request for performing cluster printing process has been accepted from the user, based on operation status information of the cluster print key 702 from a touch panel sensor. If the cluster print key 702 has been pressed down by the user, it is determined that a cluster print request is made, and processing proceeds to step S6.

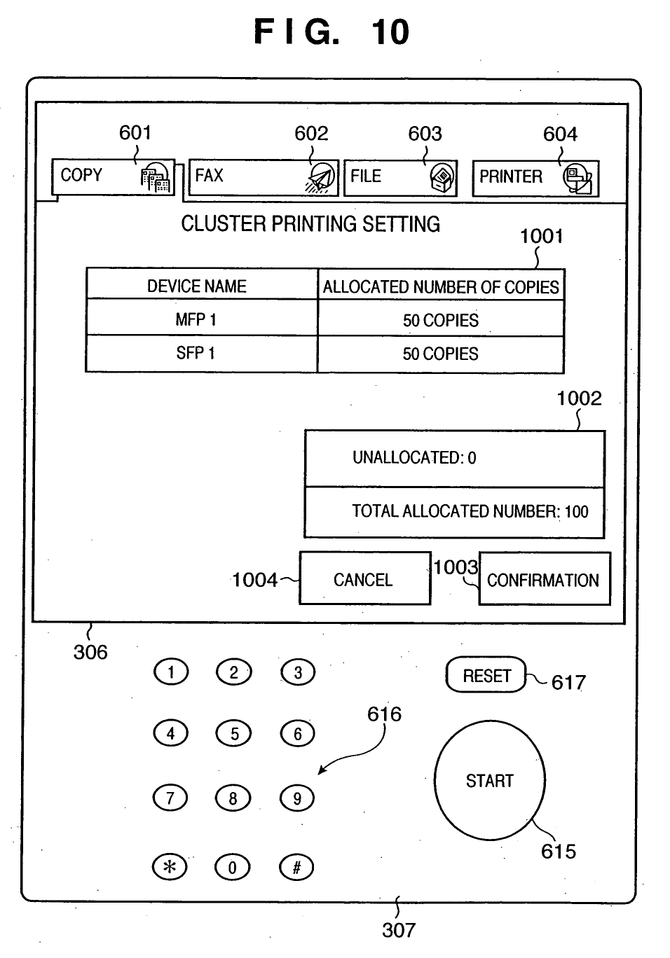

For processing at step S6, for example, the control unit 201 displays on the display unit 306 a cluster print setting screen shown in FIG. 10, and makes it possible to accept a user input via the screen. If printer selection processing is cancelled by pressing down the key 704 by the user at step S5, processing returns to step S1, where a copy mode setting screen shown in FIG. 6 is displayed on the display unit 306.

The screen of FIG. 10 displayed on the display unit 306 by the control unit 201 comprises a list 1001 and keys 1002 to 1004 as display components.

The list 1001 has a display field for notifying the user of the apparatus names of printing apparatuses selected by the user via the list 701 as printing apparatuses which are made to perform distributed printing process by pressing down the cluster print key 702. In addition, the list 1001 has a display field for notifying the user of the number of copies allocated to the apparatus, i.e. how many copies of printing process are performed by each of those printing apparatuses.

In this embodiment, it is not necessary for the user himself to calculate and allocate the number of copies allocated to each printing apparatus in cluster printing as described above, as one of mechanisms giving consideration to operability.

For example, the example of display in FIG. 10 reflects the result of the following setting made by the user in a job to be processed.

(1) 100 copies are set as a total number of print copies via the ten key 616 by the user.

(2) An instruction for performing cluster printing process by two printing apparatuses, i.e. MFP 1 (MFP 101 in FIG. 1) and SFP 1 (SFP 105 in FIG. 1), is input via the UI screen of FIG. 7 by the user.

In this embodiment, the control unit 201 determines the allocated number of copies so that the number of copies allocated to the MFP 1 is 50 and the number of copies allocated to the SFP 1 is 50, based on the user setting of (1) and (2). The control unit 201 performs control so that the user can be notified of the result via the display field 1002 on the screen of FIG. 10. This allocation method employs the equal allocation method of (1) if described with the above-mentioned example.

Namely, because the total number of copies is 100, the number of print copies allocated to the MFP 1 is determined to be 50 and the number of print copies allocated to the SFP 1 is determined to be 50. The user is not required to make such a setting.

The number of copies allocated to printing apparatuses to perform distributed printing by the control unit 201 can be changed via the display screen of FIG. 10 by the user.

For example, in FIG. 10, 50 print copies are allocated to each of the MFP 101 and the SFP 105 for 100 print copies in total. The number of copies allocated by the control unit 201 can be changed to a desired allocated number of copies and reallocated by operating the ten key 616 by the user himself. The number of copies unallocated and the total number of copies are displayed in the display field 1002. The user presses down a determinative key 1003, whereby a determinative instruction of the number of print copies allocated to each printing apparatus is accepted. Reference numeral 1004 denotes a cancel button, which is configured to accept an instruction to return to the screen of FIG. 7 by cancellation when it is desired to add an apparatus performing cluster printing, it is desired to perform alternative printing, or the like.

In FIG. 10, the apparatus name “MFP 1” corresponds to the main MFP 101, and the apparatus name “SFP 1” corresponds to SFP 105. Namely, in this embodiment, the case where cluster printing is performed using one remote printing apparatus in addition to the local printing apparatus being the self apparatus will be described. In this embodiment, one remote printing apparatus is used together with the local printing apparatus in the distributed printing operation. This is one of mechanisms giving consideration to user's use environment. In the office environment, for example, a large number of persons use the printing apparatus. Therefore, this mechanism is based on the assumption that if distributed printing is permitted using a large number of printing apparatuses for one user (one job in other words), other users may be affected when they use the printing apparatuses. In other words, it may be made possible to select one or more remote printing apparatuss to perform cluster printing for one job if there is no fear of influences exerted in the user's use environment. In this way, the print system can be flexibly constructed for suiting user's use environment.

At step S7, the control unit 201 determines whether the determinative button 1003 has been operated or the cancel button 1004 has been operated by the user. If it is determined that the determinative button 1003 has been operated, processing returns to step S1, where the copy mode setting screen of FIG. 6 is displayed on the display unit 306. An instruction can be accepted from the user via the screen of FIG. 6 again. If it is determined that the cancel button 1004 has been operated, processing returns to step S4, where the display unit 306 is made to display a list of printing apparatuses in FIG. 7, and selection of the printing apparatus can be accepted from the user again.

Setting of a series of printing process conditions for a job to be processed, including various kinds of settings described above, is completed by the user, and the start key 615 is pressed down, whereby an instruction to start a printing operation is input. In response thereto, the control unit 201 makes processing proceed from step S2 to step S8. The MFP 101 is controlled to perform a printing operation pursuant to a series of printing process conditions set by the user for a job to be processed.

For example, at step S8, the control unit 201 makes the scanner unit 202 perform an operation of reading a series of originals set on the ADF of the MFP 101 by the user. Original image data of the job read by the scanner 202 is sequentially stored in the hard disk of the storage device 304 in order from the front page. Such processing may be performed by automatically starting reading when the original is set in the reading apparatus before an input of print setting is accepted in the case of a copy operation.

At step S9, the control unit 201 determines whether or not the accepted job is a job for which cluster printing is set, based on user setting information input via the UI. For example, if the job to be processed is a job for which cluster printing is set, processing is made to proceed from step S9 to step S11.

For example, if it is determined that the accepted job is neither a job for which cluster printing is set nor a job for which remote printing is set, the control unit 201 makes processing proceed from step S9 to step S10. In other words, if the job to be processed is a job of the local print mode which is printed by the local printing apparatus 101, processing proceeds to step S10. How to treat a job of the local print mode will be described below.

Assume that the key 610 on the screen of FIG. 6 is not pressed down and other printing apparatus is not selected via the list 701 on the screen of FIG. 7 by the user, for example. In this case, the control unit 201 determines the self apparatus, i.e. the MFP 101 as a apparatuses to be selected. If in this state, the start key 615 is pressed down by the user, the control unit 201 treats the job as a local print job. A specific example will be described below.

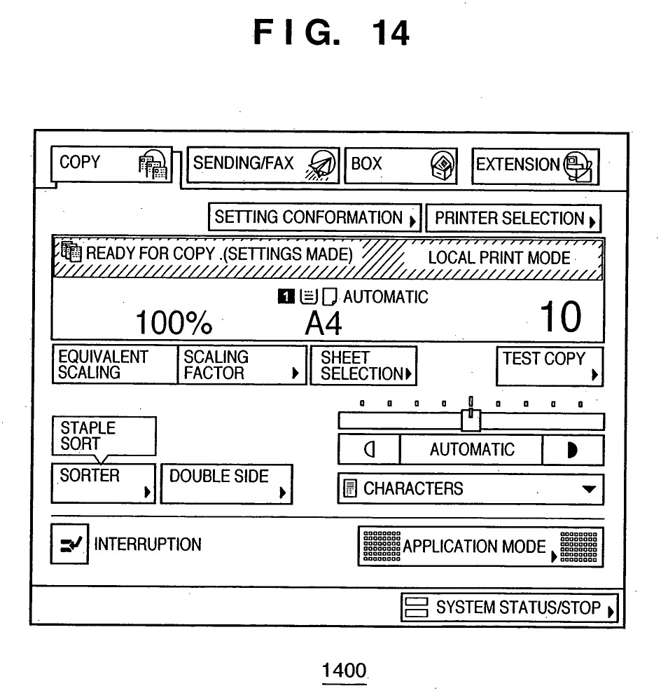

For example, assume that the user sets the following processing conditions via the UI of the MFP 101: (1) the number of print copies is set to 10; (2) A4 is selected for the size and the normal output sheet is selected for the type as sheet setting; (3) staple sort is set as setting for sheet processing; and (4) the print scaling factor is set to 100%. Assume that such conditions are set by the user. Assume that in addition, the printer selection key 610 is not pressed down, and neither the remote copy setting nor the cluster print setting is made. In this case, for example, the control unit 201 displays on the display unit 306 a screen 1400 shown in FIG. 14.

The control unit 201 performs display control to reflect processing conditions set by the user on the screen as in the screen 1400 of FIG. 14. In addition, in the above-mentioned user setting, the job is treated as a job of the local copy mode, and therefore display is provided as such. For example, as one example, display is provided such that the user can identify the job as a job of the “local printer mode” as guidance information as in FIG. 14. Assume that with such-user setting conditions, the start key 615 is pressed down, and an instruction to start printing is accepted. In this case, the control unit 201 makes only the MFP 101 itself perform printing process of the job with the job as a job of the print mode at step S10.

For example, original image data of the job stored in the storage device 304 at step S8 is read out from the memory, and the MFP 101 is made to perform printing process pursuant to the UI of FIG. 14. In this example, a sheet of which the size is A4 and the type is recycled paper is selected, and an image of the job is printed on the sheet in an image scaling factor of 100%. When one copy of printing process is completed, staple processing is performed by a sheet processing apparatus of the MFP 101. This task is performed by the MFP 101 in a quantity equivalent to the total number of print copies, i.e. 10 sets.

In this way, if the job to be processed is a job of the local print mode, the control unit 201 makes the MFP 101 perform a local printing operation as printing process of the job at step S10.

If the control unit 201 determines that the job to be processed is a job of the cluster print mode, it makes processing proceed from step S9 to step S11. At step S11, the printing apparatus selected at step S4 is requested to provide notification of function information of the apparatus. In other words, the control unit 201 requests acquirement of information about the printing apparatus selected by the user in the list 701 of FIG. 7. For example, an information request command is sent from the MFP 101 via the network 104 to the selected other printing apparatus. Assume that in response to the command, function information is sent back from, for example, the MFP 102 or SPF 105 which is other printing apparatus, and the MFP 101 receives the information. Then, the control unit 201 stores this acquired information in the RAM 302.

The control unit 201 determines based on the acquired information whether or not the printing apparatus selected as a apparatus to perform distributed printing in the list 701 can perform processing based on the setting specifics accepted from the user (step S12). The determination at step S12 may be made not for the local printing apparatus but for only the remote printing apparatus. Alternatively, the determination at step S12 may be made for printing apparatuses including the local printing apparatus. Consequently, the situation in which the number of printing sheets required in printing process of the job to be processed is insufficient is addressed in the local printing apparatus. The situation in which there is no printing sheet of a size and type required in printing process of the job to be processed is addressed. These situations are also addressed for consumable materials other than printing sheets, such as toners.

A specific example of function information received and acquired by the MFP 101 from other printing apparatus selected in the list 701 is shown in FIG. 11.

Apparatus information in FIG. 11 can be stored in each memory of each printing apparatus. The apparatus information stored in the memory of the self apparatus can be used irrespective of which printing apparatus is a master apparatus.

For the method of acquiring the apparatus information in FIG. 11, for example, the control unit 201 controls the printing apparatus so that at least any of the following two methods can be employed.

(1) A request command for requesting status information or the apparatus information is sent from the self apparatus to other printing apparatus via the network 104. Status information or apparatus information sent back from the other printing apparatus in response to the request command is registered in the memory of the self apparatus in the form of a table shown in FIG. 11. At this time, information of the self apparatus is also registered. For timing in which the control unit 201 acquires such information, for example, timing in which distributed printing is requested from the user, and/or timing in which a change in state occurs in each printing apparatus are employed. The latter is timing in which the state is changed from a state of existence of consumable materials such as printing sheets and toners to a state of nonexistence of the consumable materials, and it makes it possible to automatically acquire the above-mentioned information from the other printing apparatus.

(2) The user manually inputs apparatus information of other printing apparatus and the self apparatus via the UI of the self apparatus. The information input by the user is registered in the memory of the self apparatus in the form of the table of FIG. 11. However, information of consumable materials, and the like can be automatically acquired from a unit, such as a sensor, possessed by the apparatus.

In FIG. 11, function information 1100 has 10 kinds of information of an apparatus name 1101, a printing speed 1102, a printing sheet size 1103, a finisher 1104, a PDL (Page Description Language) 1105, a BIN number 1106, double side printing 1107, a sheet feeding cassette number 1108, existence/nonexistence of sort 1109 and an installation location 1110. This example of constitution is only one example, and the function information is not limited thereto, but may be any of the above-mentioned items, or may further include information related to the function of other printing apparatus.

In the example of FIG. 11, cluster printing is performed by two printing apparatuses, i.e. the MFP 101 and the SPF 105. Therefore, information of the “MFP 1” and “SPF 1” is included in the apparatus name 1101 of the function information 1100 acquired by the MFP 101.

The control unit 201 of the MFP 1 makes a reference to the printing sheet size information 1103 of the MPF 1. Consequently, the control unit 201 recognizes that the MPF 1 accommodates printing sheets of A3, A4, B5 and B4. The control unit 201 of the MFP 1 makes a reference to the printing speed information 1102 of the MFP 1. Consequently, the control unit 201 recognizes that the printing speed is 31 sheets per minute when the MFP 1 performs printing on output sheets of A4 size and B5 size. The control unit 201 recognizes that the printing speed is 16 sheets per minute for A3 and B4 sizes. The control unit 201 of the MFP 1 makes a reference to the finishing information 1104 of the MPF 1. Consequently, the control unit 201 recognizes that sheet processing capable of being performed by the sheet processing apparatus possessed by the MFP 1 is (1) staple processing, (2) punch processing, (3) bending processing, (4) saddle stitch processing and (5) cutting processing.

The control unit 201 makes a reference to the PDL information 1105 to recognize that the MFP 101 is set to the LIPS. The control unit 201 makes a reference to the BIN number information 1106 to recognize that the MFP 1 comprises 7 sheet discharging bins. The control unit 201 makes a reference to the double side printing information 1107 to recognize that the MFP 1 is an apparatus capable of performing double side printing. The control unit 201 makes a reference to the sheet feeding cassette number information 1108 to recognize that the MPF 1 comprises 4 sheet feeding units. The control unit 201 makes a reference to the sort function information 1109 to recognize that the MFP 1 comprises a sort function. The control unit 201 makes a reference to the installation location information 1110 to recognize that the installation location of the MFP 1 is area A.

The control unit 201 of the MFP 1 makes a reference to the printing sheet size information 1103 of FIG. 11 to recognize that the SFP 1 accommodates printing sheets of A4 and B 5 sizes. The control unit 201 makes a reference to the printing speed 1102 to recognize that the printing speed when the SFP 1 performs printing on an A4 or B5 output sheet is 16 sheets per minute. The control unit 201 of the MFP 1 makes a reference to the finishing information 1104 of the SFP 1. Consequently, it recognizes that the SFP 1 is a printing apparatus which cannot perform sheet processing such as staple. The control unit 201 makes a reference to the double side printing information 1107 to recognize that the SFP 1 is a printing apparatus capable of performing double side printing. The control unit 201 makes a reference to the sheet feeding cassette number information 1108 to recognize that the SPF 1 has three sheet feeding units. The control unit 201 makes a reference to the sort function information 1109 to recognize that the SFP 1 has a sort function. The control unit 201 makes a reference to the installation location information 1110 to recognize that the installation location of the SFP 1 is user A.

At step S12, the control unit 201 recognizes information related to functions and capacities of printing apparatuses for distributed printing described above. The control unit 201 determines whether processing is made to proceed to step S13 or step S14 based on the recognition result. For example, if it is determined that all the apparatuses selected as printing apparatuses to perform distributed printing based on the user operation in the list 701 can perform all of various kinds of processing based on instructions from the user, set in the UI, processing proceeds to step S13. If an apparatus which can not perform all of set processing among the selected printing apparatuses, processing proceeds to step S14.

At step S13, control is performed so that printing process pursuant to the specifics of all of a series of printing process conditions including a plurality of processing conditions set via the UI by the user is performed by each of all printing apparatuses selected as printing apparatuses to perform distributed printing. In this embodiment, the number of apparatuses to perform distributed printing is 2 in total, i.e. the MFP 101 corresponding to the local printer and the SFP 105 corresponding to the remote printer. At step S13, the following job generation processing is performed.

For example, the control unit 201 makes the general control manager 405 in the MFP 101 generate a job pursuant to user setting specifics from the UI. The job to be performed in the MFP 101 is given to the copy job manager 407 in the MFP 101, and the job is performed by the copy job manager 407. Thus, the printer engine 203 is controlled via the printer controller 409, and printing of the job is performed by the printer unit 203.

A job to be performed in the SFP 105 among generated jobs is sent from the MFP 101 to the SPF 105 via the network 104. The control unit 211 of the SMP 105 gives the job from the general control manager 415 in the SPF 105 to the print job manager 416. The job is performed by the print job manager 416. Thus, the printer engine 212 is controlled via the printer controller 417, and printing of the job is performed by the printer unit 212.

A specific example of control of job processing by processing at step S14 will be described.

For example, a job (hereinafter referred to as job A) input in the MPF 101 is document data of A3 size consisting of 4 pages. A plurality of processing conditions set by a user (hereinafter referred to user A) in the UI of the MFP 101 for the job A are as follows.

(Setting item 1) “A3 size” is set for the sheet size and “normal sheet” is set for the sheet type as setting of the sheet via the screen 1200 of FIG. 12.

(Setting item 2) “Double side printing” is indicated via the key 608 on the screen of FIG. 6 as setting on whether single side printing or double side printing is selected.

(Setting item 3) An instruction to perform sheet processing by a finisher is not input for setting of finishing.

(Setting item 4) “40” is set by the ten key 616 as setting of the number of print copies.

(Setting item 5) “100%” is set by the equivalent scaling key 605 as setting of the print scaling factor.

(Setting item 6) “Standard” is set for setting of the print density.

(Setting item 7) “Character” is set for setting of print image quality.

A series of processing conditions including a plurality of printing process conditions described above are set in the job A via the UI by the user A.

Further, the following setting is made by the user A.

(Setting item 8) As apparatuses to perform printing process of data of the job A, two apparatuses, the MFP 101 and the SFP 1 are selected via the UI of FIG. 7. In addition, a contributed printing instruction is input by pressing down the key 702. Thus, the control unit 201 of the MFP 101 determines that acceptance of a request for processing of the job B has been completed.

The control unit 201 of the MFP 101 determines that the job A is a job to be printed distributively (job of the cluster print mode) based on the setting (8). In addition, the control unit 201 determines that printing process based on the above setting items (1) to (7) should be performed with distributed printing of the job A by the MFP 101 and the SFP 105.

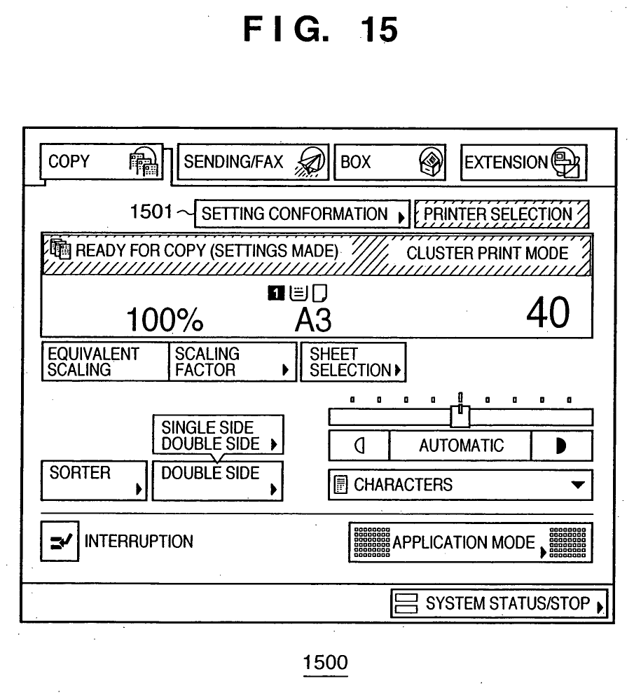

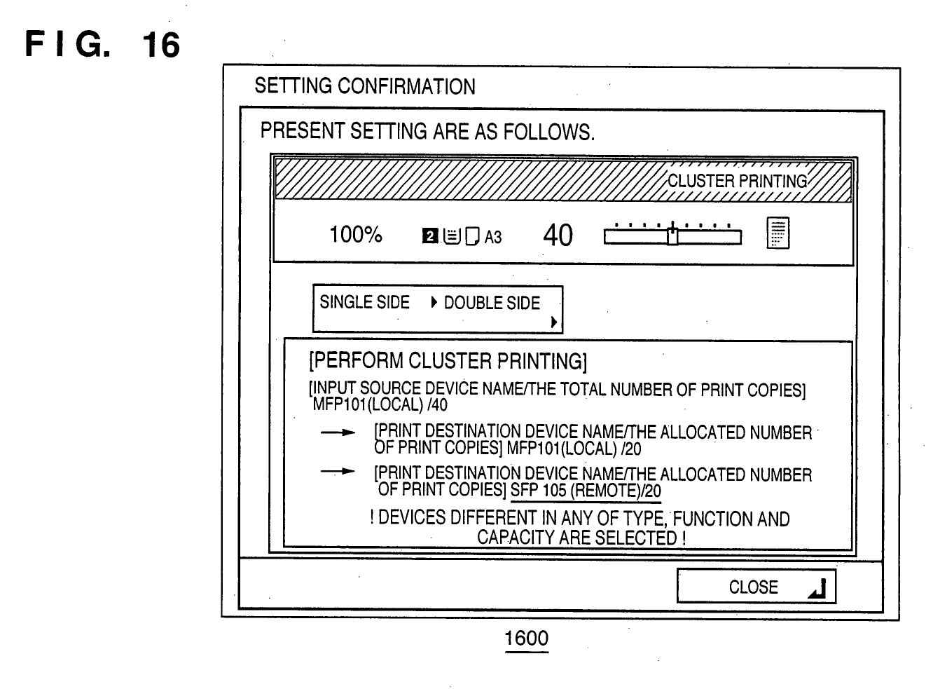

The control unit 201 of the MFP 101 makes the display unit 306 provide display making it possible to recognize what sort of processing is performed as processing of the job A by the user A. For example, a screen 1500 of FIG. 15 is displayed on the display unit 306. The control unit 201 makes the display unit 306 provide display so that various kinds of processing conditions set for the job A by the user A can be recognized as shown in FIG. 15. In addition, the display unit 306 is made to provide display of specifics distinguished from those of the screen 1400 of FIG. 14 so that it is recognized that the job A is not a job of the local print mode but a job of the cluster print mode. For example, as shown in FIG. 15, a message indicating that the job A is a job of the “cluster print mode” is displayed, and the user A is notified of the fact. When the key 1501 on the screen 1500 is pressed down, the control unit 201 makes it possible to provide setting recognition display capable of notifying the user of further detailed information about the job A by the display unit 306. For example, a setting recognition screen 1600 of the job A in FIG. 16 is displayed on the display unit 306.

In the example in FIG. 16, the control unit 201 allocates the number of print copies to the MFP 101 and the SFP 104 not based on the printing speed of the printing apparatus of the distributed printing partner but by the equal allocation method. As a result, 20 print copies are allocated to each of these printing apparatuses.

If display for recognition of the job is requested by the user, the control unit 201 of the MFP 101 makes the display unit 306 provide various kinds of displays shown in FIG. 16. For example, as shown in FIG. 16, the display unit 306 is made to provide display for recognizing the sort of print setting with which the job to be processed is subjected to printing. In addition, the display unit 306 is made to provide display for making it possible to recognize that the job is a job to be subjected to cluster printing. In addition, the display unit 306 is made to provide display making it possible to recognize by the user how many copies are printed in total, and how many copies are printed by which printing apparatus, i.e. the allocated number of copies for each printing apparatus. In addition, if apparatuses different in any of the function, the type and the capacity are selected by the user as printing apparatuses to perform distributed printing, e.g. if the MFP 101 and the SFP 105 are selected, the display unit 306 is made to provide display for making it possible to recognize the apparatuses by the user.

When the start key 615 is pressed down by the user after setting of a series of printing process conditions for the job A and recognition by the user as described above are completed, the control unit 201 starts processing of the job A.

The control unit 201 of the MPF 101 recognizes the following items for the job A.

(Recognition 1) The control unit 201 recognizes that the job A is a job for distributed printing (YES in step S9).

(Recognition 2) The control unit 201 recognizes that the number of printing apparatuses of the partner performing distributed printing of the job A is 2, i.e. the MFP 101 and the SFP 105, based on the printing apparatus selection operation by the user at step S6.

(Recognition 3) The control unit 201 recognizes that processing corresponding to the above settings (1) to (3) and (5) to (7) made by the user A can be all performed by each of these printing apparatuses based on apparatus information in FIG. 11 (YES in step S12).

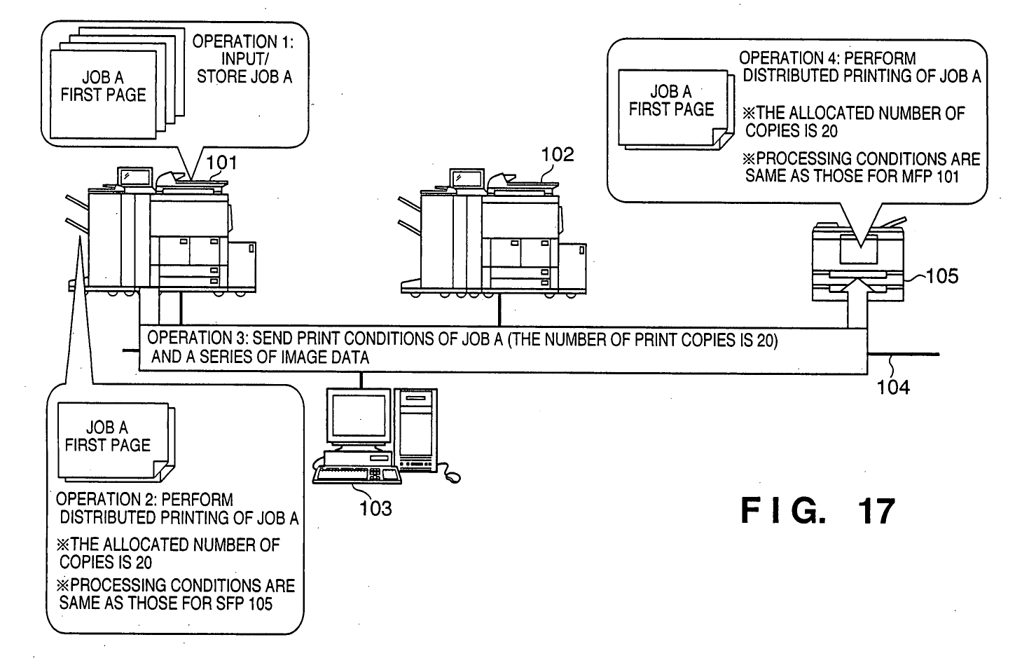

Therefore, for example, the control unit 201 of the MFP 101 makes the MFP 101 and the SFP 105 perform distributed printing process for the job A at step S13 as processing of the job A. In the distributed printing for the job A, control is performed so that the following operations are performed by the system. They will be described using FIG. 17.

(Operation 1) The control unit 201 of the MPF 101 makes the scanner 202 of the MFP 101 perform an operation of reading the original of the job A consisting of 4 pages sequentially in page order. In addition, read original data of the job A is sequentially stored in the storage device 304.

(Operation 2) The control unit 201 of the MPF 101 makes the MFP 101 perform printing on an output sheet of which the sheet size is the A3 size and the sheet type is the normal sheet, in the double side print mode, as distributed printing process of original data of the job A stored in the storage device 304. At this time, printing is performed with “100% ” set for the print scaling factor, “standard” set for the print density and “character” set for image quality.

The control unit 201 performs control so that such distributed printing process of the job A is performed such that 20 copies (20 sets) of the total number of print copies for the job A, i.e. 40 copies, are printed by the MFP 101.

(Operation 3) The control unit 201 of the MPF 101 sends original data of the job A stored in the storage device 304, printing process condition data and a distributed printing instruction command from the MFP 101 to the SFP 105 via the network 104. The number of print copies to be printed by the SFP 105 is 20, and thus data of the allocated number of copies is also sent to the SPF 105.

(Operation 4) The SFP 105 is made to perform distributed printing process of original image data of the job A received by the SFP 105 together with printing process condition data and stored in the storage device 314 of the SFP 105. This operation may be controlled principally by the control unit 211 of the SFP 105.

Control is performed so that distributed printing process of the job A in the SFP 105 is performed under conditions same as (completely consistent with) those in distributed printing process of the job A by the MFP 101.

Namely, original data of the job A is printed on an output sheet of which the sheet size is the A3 size and the sheet type is the normal sheet in the double side print mode. At this time, the SFP 105 is made to perform printing of the job A with “100%” set for the print scaling factor, “standard” set for the print density and character set for image quality.

Such distributed printing process of the job A is performed such that 20 copies (20 sets) of the total number of print copies for the job A, i.e. 40 copies, are printed by the SFP 105.

The above operations in FIG. 17 are performed by the system to complete distributed printing process of the job A.

Control is performed principally by the control unit 201 of the MPF 101 so that the operations (1) to (4) shown in FIG. 17 are performed in distributed printing process of the job A.

A further configuration of this embodiment will be described while comparing the operation (2) and the operation (4) in FIG. 17. In this embodiment, distributed printing process using the MFP 101 having a copy function, a print function, a file function and the like and the SFP 105 having a print function but not having a copy function can be performed.

Thus, in this embodiment, distributed printing can be performed by printing apparatuses having different functions and types. In addition, UI control is performed so that if a setting is made to perform distributed printing by apparatuses having different functions, the user is notified of this fact in advance as shown in FIG. 16. In addition, printing apparatuses having mutually different functions can perform distributed printing process under mutually same processing conditions depending on processing conditions set by the user in the job to be processed. As one example thereof, operations such as the operations (2) and (4) in FIG. 17 can be performed by the system.

Owing to such a configuration, problems conceived in the conventional technique are solved, a convenient system suitable for user's use environment can be constructed, and various needs from various users can be flexibly coped with.

This embodiment has the following configuration in order to improve productivity of the job. This will be described with an example of control related to the operations (1) to (4) in FIG. 17.

For example, the control unit 201 performs control so that the operation (2) by the MFP 101 and the operation (3) by the MFP 101 can be performed at least concurrently (in parallel) by the MFP 101 (hereinafter referred to as control 17-1).

Preferably, the operation (1) by the MFP 101 is made to overlap the operation (2) by the MFP 101, and these operations are performed by the MFP 101 (hereinafter referred to as control 17-2).

Preferably, the SFP 105 is controlled by the control unit 201 and/or the control unit 211 so that the operation (4) by the SFP 105 is performed in parallel with (concurrently with) the operation (2) by the MFP 101 (hereinafter referred to as control 17-3).

Thus, by employing a mechanism taking productivity of the job into account, the above-mentioned effect can be further improved.

However, control 17-2 is performed if a job in printing does not exist yet in the MFP 101. For example, if a job in printing exists yet in the MFP 101, the control unit 201 holds original image data of the job A in the storage device 304 and prohibits distributed printing of the job A by the MFP 101 until printing of the preceding job is completed. As soon as printing of the preceding job by the MPF 101 is completed, automatically, original data of the job A is read out from the storage device 304, and the operation (2) is performed by the MFP 101 as distributed printing process of the job A.

Control 17-3 is performed if a job in printing does not exist yet in the MFP 101 and a job in printing does not exist in the SFP 105. For example, if a job in printing exists yet in the SFP 105, original image data of the job A is held in the storage device 314 and distributed printing by the SFP 105 is prohibited until printing of the preceding job by the SFP 105 is completed. As soon as the printing of the preceding job by the SPF 105 is completed, automatically, original data of the job A is read out from the storage device 314, and the operation (4) is performed by the SFP 105 as distributed printing process of the job A.

Thus, in this embodiment, the above-mentioned effect is obtained, and the above-mentioned effect can be further exhibited taking the overall productivity of a plurality of jobs into account.

The above processing can be performed by the system in processing at step S13.

In the example of FIG. 16, distributed printing processing by two printing apparatuses, i.e. the MFP 101 corresponding to a printing apparatus having a plurality of functions including a copy function and a print function and the SPF 105 corresponding to a printing apparatus not having a copy function but having a print function is illustrated.

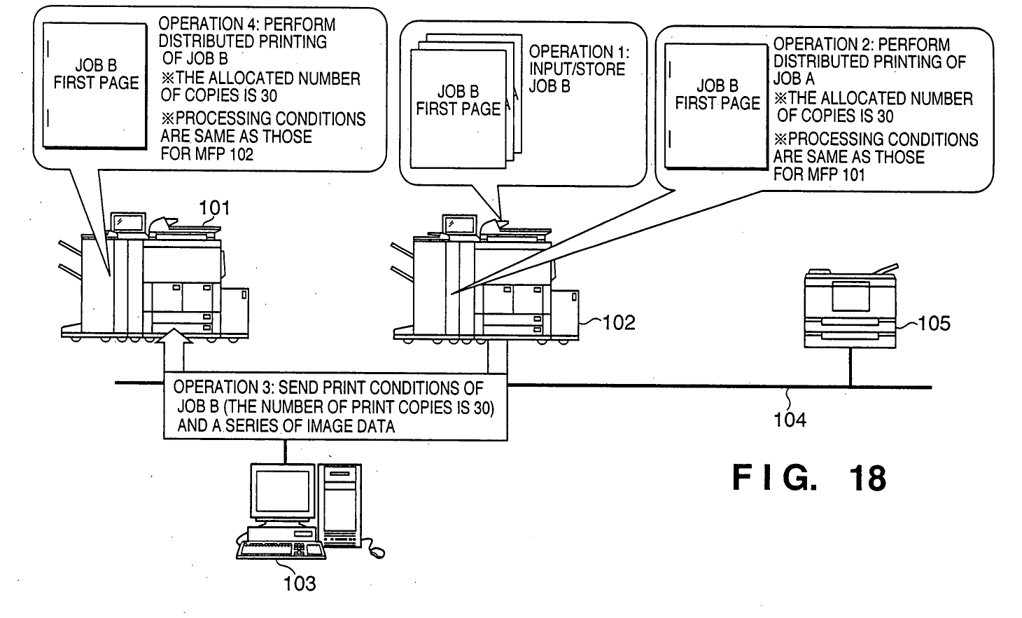

However, of course, distributed printing process by other combinations of printing apparatuses can be performed at step S13. For example, it may be distributed printing by two printing apparatuses, the MFP 101 and the MFP 102 both having a plurality of functions. It may be distributed printing by two printing apparatuses, the MFP 102 and the SFP 105. It may be distributed printing by these three printing apparatuses. As one example thereof, distributed printing process by two printing apparatuses, the MFP 101 and the MFP 102 will be described with an example of control shown in FIG. 18. In the example of FIG. 18, the master apparatus is the MFP 102 and the slave apparatus is the MFP 101. Therefore, various kinds of processing shown in the flowchart of FIG. 5A and FIG. 5B are performed principally by the control unit of the MFP 102.

For example, a job (hereinafter referred to as job B) input in the MPF 102 is document data of A4 size consisting of 3 pages. A plurality of processing conditions set by a user (hereinafter referred to user B) in the UI of the MFP 102 for the job B are as follows.

(Setting item 1) “A4 sizes is set for the sheet size and “normal sheet” is set for the sheet type as setting of the sheet via the screen 1200 of FIG. 12.

(Setting item 2) “Double side printing” is indicated via the key 608 on the screen of FIG. 6 as setting on whether single side printing or double side printing is selected.

(Setting item 3) “Staple” is set via the screen 1300 of FIG. 13 as setting of finishing.

(Setting item 4) “60” is set by the ten key 616 as setting of the number of print copies.

(Setting item 5) “100%” is set by the equivalent scaling key 605 as setting of the print scaling factor.

(Setting item 6) “Standard” is set for setting of the print density.

(Setting item 7) “Character” is set for setting of print image quality.

A series of processing conditions including a plurality of printing process conditions described above are set in the job B via the UI of the MPF 102 by the user B.

Further, the following setting is made by the user B.

(Setting item 8) As apparatuses to perform printing process of data of the job B, two apparatuses, the MFP 102 and the MFP 101 are selected via the UI of FIG. 7. In addition, a contributed printing instruction is input by pressing down the key 102. Thus, the control unit of the MPF 102 determines that acceptance of a request for processing of the job B has been completed.

The control unit of the MFP 102 determines that the job B is a job to be printed distributively (job of the cluster print mode) based on the setting (8). In addition, the control unit determines that printing process based on the above setting items (1) to (7) should be performed with distributed printing of the job B by the MFP 102 and the MFP 102.

The control unit of the MFP 102 makes the display unit of the MFP 102 provide display making it possible to recognize what sort of processing is performed as processing of the job B by the user B. In addition, the control unit of the MFP 102 controls the display unit so that display making it possible to recognize that the job B is not a job of the local print mode but a job of the cluster print mode by the user can be provided. For example, a message indicating that the job B is a job of the “cluster print mode” is displayed on the display unit of the MPF 102, and the user B is notified of this fact.

The control unit of the MFP 102 performs control so that in response to an instruction from the user, setting recognition display for notifying the user B of further detailed information for the job B can be provided by the display unit of the MFP 102. For example, if as printing process of the job B, the MFP 101 and the MFP 102 are made to perform distributed printing by the equal allocation method not depending on the printing speed, the control unit of the MPF 102 makes the display unit of the MFP 102 provide display making it possible for the user B to recognize the following matters.

(Notification 1) The total number of print copies of the job B is 60.

(Notification 2) 30 copies thereof are printed distributively by the MFP 102.

(Notification 3) Remaining 30 copies are printed distributively by the MPF 101.

The MFP 101 and the MFP 102, distributed printing partners for the job B, are printing apparatuses both having a plurality of functions.

Therefore, it is preferable that for example, the control unit of the MFP 102 prohibits display of a message of “apparatuses different in any of type, function and capacity are selected” or the like of the screen of FIG. 16 on the display unit of the MPF 102. Thus, it is preferable that control is performed so that display making it possible to determine by the user whether or not a plurality of printing apparatuses selected by the user as distributed printing partners are apparatuses different in any of type, function and capacity can be provided by the UI.

When the start key of the MFP 102 is pressed down by the user B after setting of a series of printing process conditions for the job B and recognition by the user B as described above are completed, the control unit of the MFP 102 starts processing of the job B.

The control unit of the MPF 102 recognizes the following items for the job B.

(Recognition 1) The control unit recognizes that the job B is a job for distributed printing (YES in step S9).

(Recognition 2) The control unit recognizes that the number of printing apparatuses of the partner performing distributed printing of the job B is 2, i.e. the MFP 102 and the MFP 102, based on the printing apparatus selection operation by the user at step S6.

(Recognition 3) The control unit recognizes that processing corresponding to the above settings (1) to (3) and (5) to (7) made by the user B can be all performed by each of these printing apparatuses based on apparatus information in FIG. 11 (YES in step S12).

Therefore, for example, the control unit of the MFP 102 makes the MFP 102 and the MFP 102 perform distributed printing process for the job B at step S13 as processing of the job B. In the distributed printing for the job B, control is performed so that the following operations are performed by the system. They will be described using FIG. 18.

(Operation 1) The control unit of the MPF 102 makes the scanner of the MFP 102 perform an operation of reading the original of the job B consisting of 3 pages sequentially in page order. In addition, read original data of the job B is sequentially stored in the storage device of the MFP 102.

(Operation 2) The control unit of the MPF 102 makes the MFP 102 perform printing on an output sheet of which the sheet size is the A4 size and the sheet type is the normal sheet, in the single side print mode, as distributed printing process of original data of the job B stored in the storage device of the MPF 102. At this time, printing of the job B is performed with “100%” set for the print scaling factor, “standard” set for the print density and “character” set for image quality. In addition, the output sheet of the job B is subjected to staple processing by the finisher of the MPF 102 for each copy.

Such distributed printing process of the job B is performed such that 30 copies (30 sets) of the total number of print copies for the job B, i.e. 60 copies, are printed by the MFP 102.

(Operation 3) The control unit of the MPF 102 sends original data of the job B stored in the storage device 304 of the MFP 102, printing process condition data and a distributed printing instruction command from the MFP 102 to the MFP 102 via the network 104. The number of print copies to be printed by the MFP 101 is 30, and thus data of the allocated number of copies is also sent to the MPF 101.

(Operation 4) The MFP 101 is made to perform distributed printing process of original image data of the job B received by the MFP 101 together with printing process condition data and stored in the storage device 314 of the MFP 101. Principal control of this operation may be performed by the control unit 201 of the MFP 101.

Control is performed so that distributed printing process of the job B in the MFP 101 is performed under conditions same as (completely consistent with) those in distributed printing process of the job B by the MFP 102.

Namely, original data of the job B is printed on an output sheet of which the sheet size is the A3 size and the sheet type is the normal sheet in the single side print mode by MFP 101. At this time, printing of the job B is performed with “100%” set for the print scaling factor, “standard” set for the print density and “character” set for image quality. In addition, the output sheet of the job B is subjected to staple processing by the finisher of the MPF 101 for each copy.

Such distributed printing process of the job B is performed such that 30 copies (30 sets) of the total number of print copies for the job B, i.e. 60 copies, are printed by the MFP 101.

The above operations (1) to (4) in FIG. 18 are performed by the system to complete distributed printing process of the job B.

The system is controlled principally by the control unit of the MFP 102 as a master apparatus so that the above operations (1) to (4) in FIG. 18 are performed in distributed printing process of the job B.

Timing in which the apparatus is made to perform the operations (1) to (4) in FIG. 18 and their operation conditions are same as those in the example of control in FIG. 17.

In this way, in this embodiment, a job for distributed printing is requested can be processed.

Control is performed so that operations as in FIGS. 17 and 18 can be performed if processing meeting all of a series of processing conditions having a plurality of printing process conditions set by the user for the job can be performed by each of printing apparatuses of the distributed printing partner. Namely, control is performed so that distributed printing process can be performed under same processing conditions (completely consistent processing conditions) by all of the printing apparatuses of the distributed printing partner.

In this way, in this embodiment, the system is controlled so that a job for distributed printing can be printed distributively under completely consistent processing conditions by printing apparatuses for distributed printing by processing at step S13.

The sentence of “distributed printing is performed under completely consistent processing conditions” means that for example, the following example of operation is performed by the system.

(Example of operation) Printing process is performed by each of printing apparatuses of the distributed printing partner in a print output form meeting all of a plurality of printing process conditions of a series of processing conditions having the plurality of printing process conditions set in the UI by the user just before a job for distributed printing is input.

In FIGS. 17 and 18, control is performed so that the allocated number of copies is the same for each printing apparatus because of the equal allocation form. However, if the form of allocation depending on the printing speed is employed, the allocated number of copies may be made different for each printing apparatus having a different printing speed as for the allocated number of copies. Even though the number of copies allocated is different for each printing apparatus, it may be determined that processing conditions are completely consistent processing conditions and control may be performed so that processing at step S13 can be performed if other processing conditions are consistent. Examples of processing conditions other than the number of copies include, for example, the setting items illustrated above.

In this way, in this embodiment, a flexible configuration can be preferably provided. In addition, the configuration described above is provided so that processing can be performed with any of the apparatuses, the MFP 101, the MFP 102 and the SFP 105, as a master apparatus (local apparatus). In this way, the effect of this embodiment can be sufficiently exhibited.

Control in which distributed printing is performed under incompletely consistent processing conditions by printing apparatuses for distributed printing as distributed printing process for a job for which distributed printing is requested by the user will now be described.

The sentence of “a job for distributed printing is printed distributively by printing apparatuses under incompletely consistent processing conditions” means that for example, the following example of operation is performed by the system.

(Example of operation) Distributed printing is not prohibited from being performed by each of printing apparatuses of the distributed printing partner in a print output form meeting all of a plurality of printing process conditions of a series of processing conditions having the plurality of printing process conditions set in the UI by the user just before the job is input. In other words, distributed printing is prohibited from being performed by a plurality of printing apparatuses of the distributed printing partner under mutually same conditions. However, distributed printing is performed by the plurality of printing apparatuses under processing conditions with some of the plurality of processing conditions made consistent. Preferably, printing process is performed in a print output form meeting all of the plurality of processing conditions in at least any of a plurality of printing apparatuses of the distributed printing partner. In addition, in a printing apparatus of the distributed printing partner other than the above-mentioned printing apparatus, printing process is performed in a print output form not meeting all of the plurality of processing conditions but meeting some of those processing conditions.

The system of this embodiment has two types of operation modes as operations in which distributed printing is performed under incompletely consistent conditions, and makes it possible to selectively execute these modes. One example thereof is a mode executed by the system in processing at step S16 described later and a mode executed by the system in processing at step S19. The operation mode in which distributed printing is performed under completely consistent conditions described previously is a mode executed in processing at step S13.

Namely, this embodiment can be classified into two sequences, i.e. a sequence in which distributed printing process is performed under completely consistent conditions and a sequence in which distributed printing is performed under incompletely consistent conditions. In addition, the former has one type of mode, and the latter sequence has two types of modes. Namely, this embodiment has three types of operation modes in total in distributed printing process.

In this embodiment, processing at step S14 is performed as a preliminary procedure even if processing proceeds to any of processing at step S16 and processing at step S19. Processing at step S14 is performed if NO in determination at step S12.

For example, for explanation with the example of control with FIG. 10 corresponding to one example of distributed printing by the MFP 101 and the SFP 105 with the MFP 101 as a master apparatus, the control unit 201 of the MFP 101 makes the determination. For example, if distributed printing process accommodating all of processing conditions set by the user in processing at step 1 can be performed by the MFP 101 but cannot be performed by the SFP 105, the control unit 201 of the MFP 101 proceeds to processing at step S14.

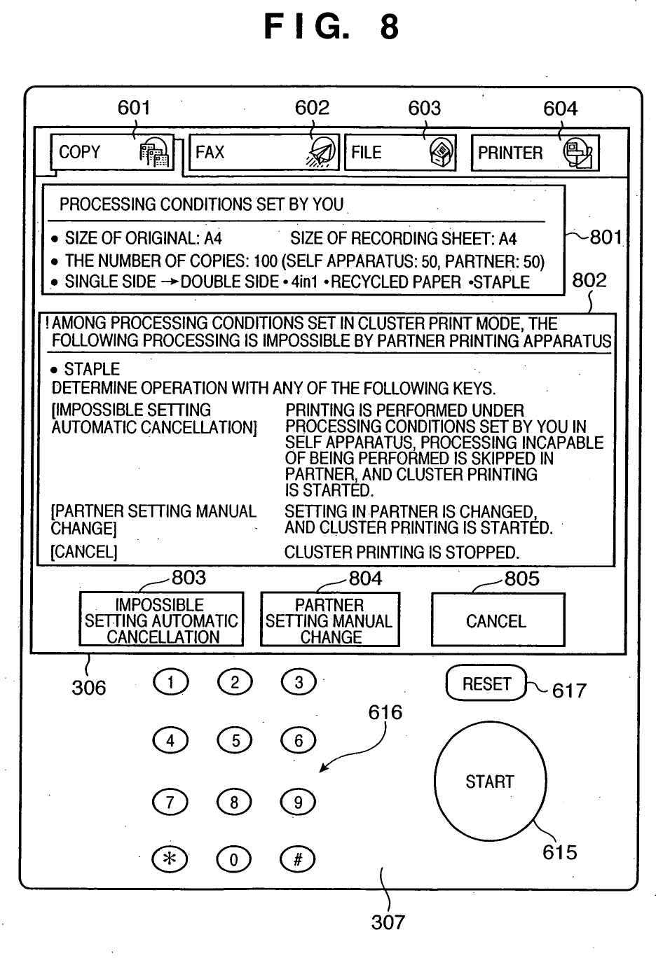

In this way, control is performed so that processing proceeds to processing at step S14 if at least any one of a plurality of printing apparatuses of the distributed printing partner can perform processing accommodating all of processing conditions set by the user. In processing at step S14, for example, the control unit 201 displays on the display 306 a clustering mode setting screen shown in FIG. 18. In this example, a UI screen of FIG. 8 is displayed on the display unit 306 of the MFP 101 because the master apparatus is the MFP 101.

In this embodiment, if at least any one of a plurality of printing apparatuses of the distributed printing partner cannot perform processing accommodating all of processing conditions set by the user, for example, the UI is made to provide display as in FIG. 8.

For example, the control unit 201 performs control so that the UI can be made to provide a plurality of displays included in the screen of FIG. 8 as display components in processing at step 14. Each of the displays will be described below.

(First display) The user requesting distributed printing process makes the UI provide display making it possible to recognize a plurality of processing conditions set via the UI in processing at step S1 by the user. In other words, in a plurality of printing apparatuses selected by the user operation, the UI is made to provide display making it possible to notify the user of the fact that completely consistent distributed printing process meeting all requirements of processing conditions set by the user cannot be performed. One example of this display provided by the UI under control of this embodiment is display in a display field 801 included in the screen of FIG. 8.

(Second display) The UI is made to provide display making it possible to recognize by the user the reason why completely consistent distributed printing process cannot be performed. Preferably, the UI is made to provide display making it possible for user to identify specifics of processing which cannot be performed. One example of this display provided by the UI under control of this embodiment corresponds to display of “the following processing is impossible in partner printing apparatuses among processing conditions set in cluster print mode. Staple” in a display field 802 included in the screen of FIG. 8.

(Third display) This embodiment prepares a plurality of measures for the case where completely consistent printing process is impossible. In other words, the image forming system of this embodiment has as functions a plurality of operation modes corresponding to a plurality of measures for a job for which completely consistent distributed printing process is impossible. Therefore, preferably, the UI is made to provide display making it possible to recognize the fact that the system has such functions by the user. One example of this display provided by the UI under control of this embodiment is display of guidance information of “determine operation with any of the following keys—cluster printing is stopped” in the display field 802.

(Fourth display) In this embodiment, a job for which completely consistent distributed printing process cannot be performed by a plurality of printing apparatuses selected as distributed printing partners can be printed distributively by those printing apparatuses in an operation mode corresponding to a first measure. The system of this example has an impossible setting automatic cancellation mode as the mode corresponding to the first measure. The control unit makes the UI provide display for making it possible to input an instruction for operating the printing apparatus of the distributed printing partner in this mode by the user. One example of this display provided by the UI under control of this embodiment is display of a display key (soft key) 803 included in the screen of FIG. 8.

This mode is an operation mode classified as a mode in which incompletely consistent distributed printing process is performed by a plurality of printing apparatuses selected as distributed printing partners.

In this example, for an apparatus which cannot perform processing compliant with setting specifics, among a plurality of printing apparatuses of distributed printing partners, only setting items for which the processing cannot be performed can be automatically cancelled to perform distributed printing. Control is performed by a control unit possessed by at least any of the master apparatus and the slave apparatus so that this operation is performed when the key 803 is pressed down by the user.

(Fifth display) In this embodiment, a job for which completely consistent distributed printing process cannot be performed by a plurality of printing apparatuses selected as distributed printing partners can be printed distributively by the printing apparatuses in an operation mode corresponding to a second measure. The system of this example has a partner setting manual change mode as a mode corresponding to the second measure. The control unit makes the UI provide display for making it possible to input an instruction for operating the printing apparatus of the distributed printing partner by the user. One example of this display provided by the UI under control of this embodiment is display of a display key (soft key) 804 included in the screen of FIG. 8.

This mode is an operation mode classified as a mode in which incompletely consistent distributed printing process is performed by a plurality of printing apparatuses selected as distributed printing partners.

For example, this embodiment can cope with the case where the printing apparatus of the partner such as the slave apparatus among a plurality of printing apparatuses of the distributed printing partner, cannot perform processing accommodating any of all processing conditions set by the user in distributed printing.

For example, distributed printing process can be performed by the apparatus under processing conditions capable of being performed by the apparatus without obeying processing conditions incapable of being performed by the apparatus while executing the setting by the user.

Such an operation can be automatically performed without an intervention operation in which the user himself cancels a setting incapable of being executed by the apparatus, or the like, if the above-mentioned impossible setting automatic cancellation mode is selected. On the other hand, the partner setting manual change mode makes it possible to perform such an operation via an intervention operation in which the user himself cancels a setting incapable of being executed by the apparatus. If the latter mode is selected, not only the user himself can cancel the setting of user processing conditions incapable of being performed by the apparatus, but also the user himself can make a change of the setting to processing conditions capable of being performed by the apparatus.

(Sixth display) This embodiment has a third measure against a job for which completely consistent distributed printing process cannot be performed by a plurality of printing apparatuses selected as distributed printing partners. The system of this example has a mode making it possible to perform cancellation processing of a job for which completely consistent distributed printing process cannot be performed as a mode corresponding to the third measure. The control unit makes the UI provide display for making it possible to input an instruction for operating the apparatus in this mode by the user. One example of this display provided by the UI under control of this embodiment is display of a display key (soft key) 805 included in the screen of FIG. 8.

For example, when the key 805 is selected by the user, the master apparatus is made to perform cancellation processing of the job for which completely consistent distributed printing cannot be performed. For example, image data of the job stored in the storage device 304 in processing at step S8 is deleted from the memory. Display control is performed for the UI to turn the display screen back into the state of FIG. 6. Then, for example, processing returns to step S1. For example, if there is other job following the job and waiting in queue for printing, printing process of the job is started. Such various kinds of cancellation processing can be performed.

The control unit of the system performs control so that the UI can provide the first to sixth displays described above. In addition, the control unit performs control so that the above-mentioned three instructions can be selectively accepted and input from the user via the fourth to sixth displays. Processing appropriate to an instruction input by the user among the three instructions can be performed by the system. The above-mentioned first to sixth displays are included in the same screen in the example of the UI in FIG. 8. However, this embodiment is not limited to such a display form. For example, some of these displays may be displayed on another screen. Each screen may be displayed on an independent screen. Thus, this embodiment may have any configuration, but preferably has a configuration giving consideration to ease of use by the user.

The screen of FIG. 8 has the display field 801 showing the specifics of the setting accepted from the user. The control unit processing condition information of a job for distributed printing set by the user in processing at step S1, and reflects the information on the display field. The screen of FIG. 8 has the display field 802 displaying information showing the specifics of processing which cannot be performed in any of printing apparatuses of distributed printing partners selected via the list 701 of FIG. 7. This information is based on processing condition information set by the user in processing at step S1, and apparatus information of the apparatus information in the management table of FIG. 11 corresponding to apparatuses selected in the list 701. In addition, operation guidance information for the user is displayed on the display field 802. The screen of FIG. 8 has the impossible setting automatic cancellation button 803, the partner setting manual change button 804 and the cancellation button 805 as described above.

This embodiment makes use of printing apparatuses capable of performing distributed printing process in a print output form meeting all of processing conditions set by the user, among a plurality of printing apparatuses corresponding to apparatuses of partners of distributed printing of a job to be processed. In addition, this embodiment makes use of printing apparatuses which cannot perform distributed printing process in a print output form meeting all of the plurality of processing conditions. Moreover, use of both the printing apparatuses at the same time as printing apparatuses of partners of distributed printing of a job to be processed is permitted.

For instance, in the example of FIG. 8, two apparatuses, the MFP 101 and the SFP 105, are selected for distributed printing process of one job. As presented in the display field 801, a plurality of processing conditions set by the user are as follows.

(Processing condition 1) The size of the original is “A4 size”.

(Processing condition 2) The size of the printing sheet is “A4 sizes”.

(Processing condition 3) The total number of print copies is “100”.

(Processing condition 4) “Double side printing” is set for single side printing or double side printing.

(Processing condition 5) “4 in 1” is set for the print layout.

(Processing condition 6) The type of printing sheet is “recycled paper”.

(Processing condition 7) “Staple” is set for sheet processing.

Among them, processing conditions (2, 4, 5, 6) correspond to processing conditions directly associated with the form (quality) of the print output result. The number of copies “100” of the processing condition (3) is the total number of print copies before allocation. The processing condition relating to the number of print copies does not correspond to the processing condition directly associated with the print output form. It is a processing parameter required when the quantity of print performed by each printing apparatus is specified.

The MFP 101 comprises at least a plurality of sheet feeding units housing a plurality of types of sheets, a memory capable of storing a plurality of image data, a double side unit for performing double side printing, and a finisher capable of performing finishing such as staple. By using these units and the like, the MPF 101 can perform printing process of the job in a print output form meeting all of processing condition 1 to 7 for the job.

On the other hand, the SFP 105 comprises at lest a plurality of sheet feeding units housing a plurality of types of sheets, a memory capable of storing a plurality of image data, and a double side unit for performing double side printing. Therefore, by using these units and the like, the SPF 105 can perform printing process of the job in a print output form meeting processing conditions (1 to 6) for the job. However, the SFP 105 does not comprise the finisher capable of performing staple processing. Therefore, printing process of the job cannot be performed in an output form with processing based on the processing condition (7) for the job, i.e. staple processing.

The control unit 201 of the MFP 101 corresponding to the master apparatus of this embodiment reflects on the display field 802 the results of the above-mentioned various kinds of recognitions made in processing at step S12. For example, the message of “the following processing is impossible in partner printing apparatuses among processing conditions set in cluster print mode” is displayed on the display field 802 of the screen of the FIG. 8, and “Staple” is displayed as the following processing. This makes the user recognize that staple processing cannot be performed by the SFP 105 if distributed printing is performed in this state using the MFP 101 and the SFP 105. A measure for the matter can be determined by the user himself by selection of any of three buttons on the screen of FIG. 8 after the user recognizes the above fact.

Assume that as in the example in FIG. 8, at least one of a plurality of printing apparatuses to be used as apparatuses of distributed printing partners cannot perform distributed printing process under processing conditions completely consistent with a plurality processing conditions first requested by the user. In this embodiment, even if such a case occurs, this printing apparatus can be included as one of printing apparatuses of distributed printing partners to perform distributed printing.

For instance, in the example of control in FIG. 8, the MFP 101 as a master apparatus can print the job in a print output form meeting all of a plurality of processing conditions (2, 4, 5, 6, 7) directly associated with the print output form first requested by the user.

On the other hand, the SFP 105 as a slave apparatus can print the job in a print output form meeting processing conditions (2, 4, 5, 6) of the above-mentioned plurality of processing conditions (2, 4, 5, 6, 7) first requested by the user. However, printing process of the job cannot be performed in a print output form accommodating the processing condition (7). In the example in FIG. 8, staple processing cannot be performed by the SFP 105.

In this print system, control in which the apparatus automatically prohibits performance of distributed printing process by two apparatuses, the MFP 101 and the SFP 105, as distributed printing process of the job is not performed even in the above-mentioned case.

For example, control in which the apparatus automatically performs an operation of searching for a printing apparatus other than the SFP 105 capable of processing equivalent to processing by the MFP 101 and using the printing apparatus and the MFP 101 to perform distributed printing, or the like is not performed.

In this print system, control is performed so that distributed printing process using both of a printing apparatus capable of printing in a print form meeting all of a plurality of processing conditions directly associated with the print form first requested by the user (hereinafter also referred to as completely consistent printing apparatus) and a printing apparatus incapable of printing process in an output form meeting all of the plurality of processing conditions (hereinafter also referred to as incompletely consistent printing apparatus) as apparatuses of distributed printing partners can be performed.

A printing apparatus capable of printing in a print form meeting at least some of a plurality processing conditions directly associated with the print form first requested by the user is preferably used as the incompletely consistent printing apparatus.

For example, even in the case of FIG. 8, control is performed so that distributed printing process by two apparatuses, the MFP 101 and the SFP 105, is permitted to be performed as distributed printing process of the job. Thus, even in the case of FIG. 8, both the MFP 101 and SFP 105 are directly selected as printing apparatuses of the distributed printing partner, and control is performed so that distributed printing process of the job can be performed by these apparatuses.

Moreover, in this system, control is performed so that distributed printing process can be performed in a state in which processing conditions directly associated with the print form are different for the completely consistent printing apparatus and the incompletely consistent apparatus selected as distributed printing partners.

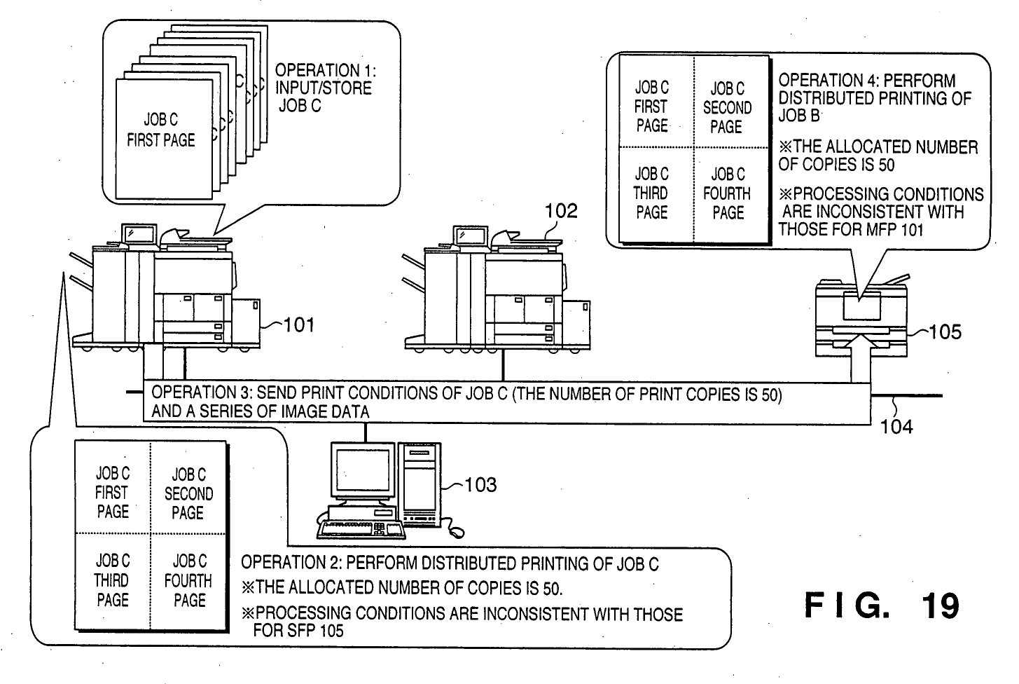

For example, in the case of FIG. 8, control is performed so that the following operations can be performed by the MFP 101 and the SFP 105 as distributed printing of the above-mentioned job (hereinafter referred to as job C) with the above-mentioned processing conditions (1) to (7) set by the user (hereinafter referred to as user C). Data of the job C is constituted by document data consisting of 16 pages of A4 size. The principal entity is the MFP 101 corresponding to the master apparatus. The operations will be described using the example of control in FIG. 19.

(Operation 1) The control unit 201 of the MPF 101 makes the scanner 202 of the MFP 101 perform an operation of reading the original of the job C consisting of 16 pages sequentially in page order. In addition, read original data of the job C is sequentially stored in the storage device 304.

(Operation 2) The control unit 201 of the MPF 101 makes the MFP 101 perform printing on an output sheet of which the sheet size is the A4 size and the sheet type is the normal sheet, in the double side print mode, as distributed printing process of original data of the job C stored in the storage device 304. At this time, one surface of a printing sheet is subjected to 4 in 1 layout processing of arranging document data of 4 pages of original. Namely, images of 4 pages are processed in a reduced layout on the front surface and the rear surface, respectively, of a printing sheet. The original has 16 pages, and therefore the total number of sheets of one copy is 16÷4÷2=2. The output sheet of the job C is subjected to staple processing by the finisher of the MPF 101 for each copy.

Such distributed printing process of the job C is performed such that 50 copies (50 sets) of the total number of print copies for the job C, i.e. 100 copies, are printed by the MFP 101.

(Operation 3) The control unit 201 of the MPF 101 sends original data of the job C stored in the storage device 304, printing process condition data and a distributed printing instruction command from the MFP 101 to the SFP 105 via the network 104. The number of print copies to be printed by the SFP 105 is 50, and thus data of the allocated number of copies is also sent to the SPF 105. Here, the processing conditions are incompletely consistent, and therefore a command of an instruction to perform staple processing is prohibited from being sent from the MFP 101 to the SFP 105.

(Operation 4) The SFP 105 is made to perform distributed printing process of original image data of the job C received by the SFP 105 together with printing process condition data and stored in the storage device 314 of the SFP 105. This operation may be controlled principally by the control unit 211 of the SFP 105.

Control is performed so that distributed printing process of the job C in the SFP 105 is performed under conditions different from (incompletely consistent with) those in distributed printing process of the job C by the MFP 101.

In this example, the SFP 101 is made to perform printing in the double side print mode on an output sheet on which the sheet size is the A4 size and the sheet type is recycled paper. At this time, one surface of a printing sheet is subjected to 4 in 1 layout processing of arranging document data of 4 pages of original. Namely, images of 4 pages are processed in a reduced layout on the front surface and the rear surface, respectively, of a printing sheet.

The printing process step by the SFP 105 to this point coincides with the step by the MFP 101 of the other distributed printing partner. Staple processing of processing conditions to be performed by the MFP 101 for distributed printing of the job C is prohibited from being performed by the SFP 105. For example, the output sheet of the job C is directly discharged to the discharging unit by the SFP 105 without performing finishing.

Such distributed printing process of the job C is performed such that 50 copies (50 sets) of 100 copies corresponding to the total number of print copies for the job C are printed by the SFP 105.

The above operations 1 to 4 in FIG. 19 are performed by the system to complete incompletely consistent distributed printing process of the job C.

In other words, the above operations (1) to (4) in FIG. 19 are performed to quickly obtain total 100 sets of output results in which the print form of the job C is partly different for the MFP 101 and the SFP 105.

Control can be performed so that timing in which the apparatus is made to perform the operations (1) to (4) in FIG. 19 and the operation conditions are same as those in the example of control in FIG. 17 and the example of control in FIG. 18.

In the image forming system of this embodiment, control is performed so that distributed printing process using both the completely consistent printing apparatus and incompletely consistent printing apparatus as apparatuses of distributed printing partners can be performed. In addition, control is performed so that distributed printing process in a state in which processing conditions directly associated with the print form are different for the completely consistent printing apparatus and the incompletely consistent printing apparatus selected as distributed printing partners can be performed. This distributed printing process is referred to as incompletely consistent distributed printing process. This corresponds to a sequence for performing distributed printing in an incompletely consistent manner.

The examples of control in FIGS. 17 and 18 are compared with the example of control in FIG. 19. The examples of job control in FIGS. 17 and 18 correspond to a sequence for performing incompletely consistent distributed printing process.

In the example in FIG. 17, the MFP 101 and the SFP 105 both correspond to the completely consistent printing apparatus in distributive processing of the job A. The reason for this is that these apparatuses both correspond to the printing apparatus capable of distributed printing of the job A in a print form meeting all of a plurality of processing conditions directly associated with the print form requested by the user A at step S1.

In the example in FIG. 18, the MFP 102 and the MFP 101 both correspond to the completely consistent printing apparatus in distributive processing of the job B. The reason for this is that these apparatuses both correspond to the printing apparatus capable of distributed printing of the job B in a print form meeting all of a plurality of processing conditions directly associated with the print form requested by the user B at step S1.

In the example in FIG. 19, the MFP 101 corresponds to the completely consistent printing apparatus in distributive processing of the job C. The SFP 105 corresponds to the incompletely consistent printing apparatus in distributive processing of the job C. The reason for this is that the MFP 101 corresponds to the printing apparatus capable of distributed printing of the job C in a print form meeting all of a plurality of processing conditions directly associated with the print form requested by the user C at step S1. On the other hand, the SFP 105 corresponds to the printing apparatus incapable of performing distributed printing of the job C in a print form meeting all of a plurality of processing conditions directly associated with the print form requested by the user C at step S1.

As described above, in the system of this embodiment, not only completely consistent distributed printing process can be performed, but also incompletely consistent distributive processing can be performed, as a mechanism giving consideration to user's use environment and use case.

In this way, situations conceived in the conventional technique can be coped with, and various needs from various users can be flexibly coped with. Incompletely consistent distributed printing process as in this embodiment can be performed, whereby the following situations can be coped with.

For example, effective use of distributed printing can be easily realized in a practical office environment. Particularly, the problem such that distributed printing can be performed only by printing apparatuses of the same series or having equivalent functions can be solved. In other words, for example, distributed printing can be achieved even if a plurality of apparatuses having functions capable of performing processing exactly as requested by the user do not exist in the system. Even in a use environment where apparatuses of different types such as the MFP and the SFP coexist in the office, but printing apparatuses of the same type do not exist in the office, the effect of this system can be exhibited. Thus, a flexible system construction taking root in a practical site becomes possible.

Owing to the configuration of this embodiment, various kinds of user needs in the practical environment can be flexibly coped with. For example, a situation in which a user holding a various kinds of requests associated with the output form of a document wants the printing apparatus to deal with processing if possible while the user thinks that even if the processing cannot be dealt with, it does not raise a significant problem, or the like can be flexibly coped with. Particularly, a situation in which in such a case, the user holds a request for having distributed printing done preferentially even at the cost of some of processing conditions, or the like can be coped with. In other words, in the system conceived previously, it is conceivable that there may a limitation such that distributed printing is impossible unless all of processing conditions requested by the user are met. This problem can also be coped with.

The print system of this embodiment employs various mechanisms as a result of giving consideration to needs of the practical environment while seeking to obtain the above-mentioned effect.

As one example thereof, for example, the user can determine whether or not the above-mentioned incompletely consistent distributed printing process is performed by this system at least before the incompletely consistent distributed printing process is completed.

Preferably, for example, whether or not incompletely consistent distributed printing process is performed can be determined before the incompletely consistent distributed printing process is started by this system, for example in timing of performing processing at step S14 in FIG. 5A. For example, the UI of FIG. 8 is presented in timing before the reading of the job is started, for example in timing of YES in processing at step S2. The above-mentioned determination may be left to the user via the UI.

Thus, the user of the job may be capable of making a selection on whether or not incompletely consistent distributed printing process is performed, via the UI of the master apparatus, before original image data of the job is all stored in the storage device of the master apparatus. In other words, a selection can be made by the user on whether or not incompletely consistent distributed printing process is performed, via the UI, before original image data of the job is transferred to the storage device of the slave apparatus or before printing is started by the slave apparatus.

As described above, incompletely consistent distributed printing may be prohibited from being performed freely without the consent of the user. In this way, for example, the problem such that incompletely consistent distributed printing process is performed even though the user does not want it can be prevented in advance. In other words, even if distributed printing cannot be performed in processing conditions first requested by the user, distributed printing by printing apparatuses different in type and function can be performed in an output form of which the user is convinced.

Thus, this embodiment exhibits an effect of making it possible to make effective use of a plurality of devises existing in the system without requiring the user to do complicated operations and after getting user's consensus. Namely, the above-mentioned effect of this embodiment can be further improved.

In addition, in this embodiment, as one example of an additional mechanism further improving the above-mentioned effect, the following aspects can be provided by the system.

For example, for performing the incompletely consistent distributed printing operation using a plurality of printing apparatuses of the system, the user can execute a desired one of the following two modes.

[First Incompletely Consistent Distributive Print Mode: Impossible Setting Automatic Cancellation Mode]

This mode corresponds to an operation performed by each printing apparatus of the distributed printing partner when an instruction to execute the impossible setting automatic cancellation mode is input through the key 803 of the UI in FIG. 8, for example. This example corresponds to an example in which the determination of YES is made at step S15, and then processing at step S16 is performed.

In this mode, operation A described below is performed by the incompletely consistent printing apparatus for a job for distributed printing. In addition, operation B described below is automatically performed by the completely consistent printing apparatus in parallel with (concurrently with) the operation A.

(Operation A) Printing process conditions incapable of being performed by the incompletely consistent printing apparatus among a plurality of printing process conditions set for a job to be processed before the user inputs a distributed printing instruction are automatically cancelled (neglected) in the incompletely consistent printing apparatus. In other words, processing incapable of being performed by the incompletely consistent printing apparatus can be skipped to perform distributed printing for the job by the apparatus. However, preferably, control is performed so that distributed printing of the job can be performed by the incompletely consistent printing apparatus in a print output form compliant with processing conditions capable of being performed by the incompletely consistent printing apparatus among the plurality of printing process conditions. On the completely consistent printing apparatus side, processing incapable of being performed by the incompletely consistent printing apparatus is not cancelled (skipped) but kept effective. In other words, control is performed so that distributed printing in a print output form compliant with all of the above-mentioned plurality of printing process conditions can be performed by the completely consistent printing apparatus for the job.

Thus, distributed printing process is performed as the operation A by the incompletely consistent printing apparatus in a print output form neglecting some processing conditions and compliant with remaining processing conditions among the plurality of processing conditions.

Operation B described below is performed by the completely consistent printing apparatus in parallel with (concurrently with) automatically performing the series of operation A by the incompletely consistent printing apparatus.

(Operation B) Distributed printing process of the above-mentioned job is automatically performed by the above-mentioned completely consistent printing apparatus in a print output form compliant with all of the plurality of printing process conditions.

The operation A by the incompletely consistent printing apparatus and the operation B by the completely consistent printing apparatus are concurrently (in parallel) automatically performed as distributed printing process. This is one example of first incomplete consistent distributive print mode processing which is performed by these printing apparatuses at step S16.

If the job C in FIG. 19 is printed distributively in this mode, the following procedure is used.

For example, the control unit 201 makes the MFP 101 perform the operation 1 in FIG. 19 as processing at step S8 in FIG. 5A. Then, the display unit 306 is made to provide display of FIG. 8 as display related to the job C at step S14 in FIG. 5A. When the key 803 of the UI screen of FIG. 8 is pressed down by the user C as an action for the job C, the control 201 proceeds to processing at step S16. The control unit 201 makes the MFP 101 perform the operations 2 and 3 in FIG. 19, for example, as processing at step S16. In addition, the SFP 105 is made to perform the operation 4 in FIG. 19.

The above operations (1) to (4) in FIG. 19 are performed to complete first incompletely consistent distributed printing process for the job C.

In this mode, the SFP 105 in FIG. 19 performs printing process as distributed printing process of the job C under processing conditions in which the setting of staple is automatically cancelled and other settings are all compliant with an instruction from the user.

The setting of staple is a setting belonging to the setting of finishing. Processing conditions belonging to the setting of finishing may include a plurality of candidates other than staple, such as punch processing and cutting processing. If a processing condition set by the user is automatically cancelled as described above, and also a selection candidate substituting for the processing condition exists, the processing condition is controlled to adopt a default value. A specific example will be described below.

For example, in the SFP 105, “nonsort” is registered as a default setting, as the setting of finishing. In this case, in the SFP 105, control is performed so that the processing condition associated with finishing of the job C is not “staple” but “nonsort”.

For example, the SFP 105 does not have a staple function, but has a shift sheet discharging function as a function included as one of functions of finishing. The shift sheet discharging function is, for example, a function of placing a plurality of copies of output sheets on a sheet discharging tray in a shifted state for each sheet bundle equivalent to one copy.

Assume that the SFP 105 has the shift sheet discharging function and “shift sheet discharge” is set in the SFP 105 as a default setting for finishing. In this case, in the SFP 105, control is performed so that the setting condition for finishing is not “staple” but “shift sheet discharge”.

Assume that when the processing condition for the job to be processed is automatically cancelled in the first incompletely consistent distributive print mode, a processing condition substituting for the condition exists in the incompletely consistent printing apparatus. In this case, the apparatus may be controlled so that the default value of the setting to which the condition belongs is automatically set for the job.

[Second Incompletely Consistent Distributive Print Mode: Partner Setting Manual Change Mode]

This mode corresponds to an operation which is performed by each printing apparatus of distributed printing partner when an instruction to execute the partner setting manual change mode is input via the UI by the user with the key 804 of the UI. This example corresponds to an example in which the determination of YES is made at step S17, and then processing at step S18 and step S19 is performed.

The second incompletely consistent distributive print mode is different in control of the incompletely consistent printing apparatus compared with the above-mentioned first incompletely consistent distributive print mode. Control of the completely consistent printing apparatus is same as that in the above-mentioned first incompletely consistent distributive print mode.

For example, in this mode, the operation A is performed by the completely consistent printing apparatus for the job for distributed printing. However, operation C described below is performed by the incompletely consistent printing apparatus in parallel with (concurrently with) the operation A.

(Operation C) Printing process conditions incapable of being performed by the incompletely consistent printing apparatus among a plurality of processing conditions set by the user for the job to be processed before inputting a distributed printing instruction are cancelled in the incompletely consistent printing apparatus. In addition, the user himself renewedly sets substitute processing conditions. Distributed printing process of the job is performed by the incompletely consistent printing apparatus in a print output form compliant with printing process conditions capable of being performed by the incompletely consistent printing apparatus among the printing process conditions and the processing conditions renewedly set by the user.

Thus, the user renewedly sets some of the plurality of processing conditions, and for other processing conditions, distributed printing process is performed as the operation C by the incompletely consistent printing apparatus in a print output form compliant with the initial setting.

If the job C in FIG. 19 is printed distributively in this mode, the following procedure is used.

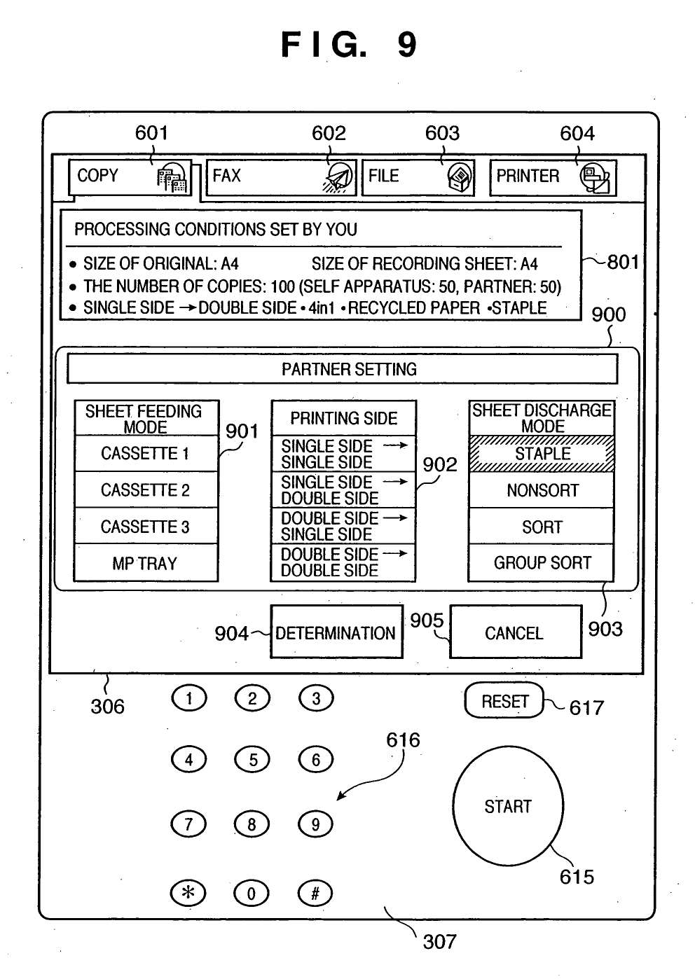

For example, the control unit 201 makes the MFP 101 perform the operation 1 in FIG. 19 as processing at step S8 in FIG. 5A. Then, the display unit 306 is made to provide display in FIG. 8 as display relating to the job C at step S14 in FIG. 5A. In response to the key 804 on the UI screen of the FIG. 8 being pressed down by the user C as an action for the job C, the control unit 201 makes processing proceed to step S18. At step S18, for example, the UI of FIG. 9 described later is displayed on the display unit 306. Via this screen, one of a plurality of selectable candidates other than “staple”, for example “nonsort” is set as setting of finishing of the SFP 105. Thereupon, the control unit 201 makes the MFP 101 perform, for example, the operation 2 and the operation 3 in FIG. 19 as processing at step S19. In addition, the SFP 105 is made to perform the operation 4 in FIG. 19.

The above operations (1) to (4) in FIG. 19 are performed to complete second incompletely consistent distributed printing process for the job C.

As described above, this embodiment employs various mechanisms for obtaining the above-described effect while paying regard to the will of the user. Now, description will return to explanation of each step in FIGS. 5A and 5B.

At step S15, the control unit 201 determines whether or not the impossible setting automatic cancellation button 803 has been selected by the user. If it is determined that the impossible setting automatic cancellation button 803 has been selected by the user, processing proceeds to step S16.

In processing at step S16, control is performed so that each printing apparatus is made to perform the following two operations. For example, in the MFP 101 which is the self apparatus, distributed printing is performed in such a manner as to comply with all of set specifics of print conditions accepted from the user at step S1. On the other hand, the remote printing apparatus incapable of complying with all of the above-mentioned setting specifics is operated as follows. For example, processing corresponding to processing conditions incapable of being performed by the remote printing apparatus among processing conditions set by the user is automatically skipped (neglected). However, processing complying with setting specifics capable of being performed by the apparatus, other than setting specifics incapable of being performed by the apparatus, is performs by the remote printing apparatus. Such distributed printing process is performed.

For the MFP. 101, a job complying with setting specifics allocated in the same manner as described above is generated by the general control manager 405, and printing process is performed. Even if an additional remote printing apparatus capable of processing compliant with setting specifics is present although not present in this embodiment corresponding to the flowcharts of FIGS. 5A and 5B, processing is performed in the same manner. For example, a job complying with setting specifics allocated to the remote printing apparatus is generated in the general control manager 405, and sent to each remote printing process via the network 104, and printing process is performed.

For the remote printing apparatus in which processing incapable of being performed exits, the general control manager 405 generates a job excluding the processing incapable of being performed, and sends the job to the remote printing apparatus via the network 104. For example, in the case of this example, the SFP 105 cannot perform staple processing. Therefore, in this example, the general control manager 405 of the MFP 101 generates a job excluding staple processing as a job for the SFP 105, and sends the job to the SPF 105 via the network 104. For example, in the example in FIG. 8, distributed printing process excluding staple processing of the processing condition (7) of processing conditions (1) to (7) is performed in compliance with initial setting specifics (1) to (6) on the SPF 105 side.

In the example in FIG. 8, on the MFP 101 side, distributed printing process compliant with all of processing conditions (1) to (7) is performed in parallel with (concurrently with) processing by the SFP 105 described above.

Thus, if the impossible setting automatic cancellation button 803 is selected, control is performed so that only processing possible in each printing apparatus can be automatically performed without renewedly setting print conditions after the user establishes print conditions at step S1. Such cluster printing can be carried out. Preferably, the completely consistent printing apparatus is made to perform distributed printing process compliant with all processing conditions initially set by the user. The incompletely consistent printing apparatus is made to perform distributed printing process compliant with at least some of processing conditions initially set by the user.

If it is determined at step S15 that the impossible setting automatic cancellation button 803 has not been selected, processing proceeds to step S17. At step S17, the control unit 201 determines whether or not the partner setting manual change button 804 on the UI screen of FIG. 8 has been selected by the user. If it is determined that the partner setting manual change button 804 has been selected, processing proceeds to step S18. At step S19, the control unit 201 displays on the display unit 306 a manual setting screen with one example thereof shown in FIG. 9. In addition, control is performed so that input of an instruction from the user can be accepted via the display.

The screen of FIG. 9 displayed on the display unit 306 by the control unit 201 has the following display components.

One of them is, for example, a display field 801. This performs a function same as that of the display field 801 of FIG. 8. Namely, it is a display field providing display showing a series of print conditions initially set by the user at step S1.

A display field 900 of FIG. 9 is a resetting input field for making it possible to renewedly set processing condition by the user by changing processing conditions incapable of being performed by the incompletely consistent printing apparatus among processing conditions set by the user at step S1 to processing conditions capable of being performed by the apparatus.

Parameters renewedly set by the user via the input field 900 are processing conditions which are functioned only for the incompletely consistent printing apparatus. In other words, if both the completely consistent printing apparatus and incompletely consistent printing apparatus are included as distributed printing partners for the job to be processed, control is performed as follows.

For example, control is performed so that processing conditions renewedly set via the input field 900 do not function for the completely consistent printing apparatus, but function only for the incompletely consistent printing apparatus. Control is performed so that the completely consistent printing apparatus is made to perform processing compliant with all of processing conditions initially set by the user at step S1 as distributed printing process. Control is performed so that the incompletely consistent printing apparatus is made to perform processing compliant with processing conditions capable of being performed by the apparatus and processing conditions renewedly set in the input field 900 among processing conditions set by the user at step S1. This will be described below with FIG. 19.

For example, in the MFP 101 corresponding to the completely consistent printing apparatus in distributed printing of the job C, distributed printing of the job C is performed in a print form meeting all of processing conditions (1) to (7) for the job C. The MFP 101 is made to perform this printing process by 50 sets equivalent to the number pf print copies allocated to the MFP 101. Namely, control is performed so that the MFP 101 is made to perform the operation 2 in FIG. 19.

In the SFP 105 corresponding to the incompletely consistent printing apparatus in distributed printing of the job C, staple processing of the processing condition (7) of processing conditions (1) to (7) for the job C is a processing condition incapable of being performed.

The control unit 201 displays on the display unit 306 setting candidates for processing conditions capable of being performed by the SFP 105 in the input field 900 of FIG. 9. For example, in a sheet discharge mode setting field 903 of the input field 900, candidates of finishing capable of being performed by the SFP 105 are displayed. Preferably, display making it possible for the user to recognize setting conditions incapable of being performed by the apparatus is provided. In this example, the item corresponding to the setting of staple is displayed in gray-out. By the display control, selection of the staple mode for the SFP 105 is prohibited. In addition, control is performed so that “nonsort/sort/group sort” corresponding to other selection candidates of finishing capable of being performed by the SFP 105 is in an effective display state. Control is performed so that a desired setting of finishing can be selected therefrom by the user for the SFP 105. For example, if “nonsort” is selected by the user in the finishing setting change field 903, the control unit 201 accepts a change of setting of finishing for the SFP 105 from the user.

When the above-mentioned setting change operation by the user is completed, and a determination key 904 is pressed down by the user, the control unit 201 sends, for example, various kinds of data described below from the MFP 101 to the SFP 105 as the operation (3) in FIG. 19.

(1) A series of image data of the job C (print data of 16 pages).

(2) Parameters of processing conditions (1) to (6) for the job C (parameter indicating 50 copies corresponding to the number of copies allocated to the SFP 105 for the number of print copies for the processing condition 3).

(3) Parameter after changing the setting of the processing condition (7), i.e. “nonsort”.

When the SFP 105 receives the above-mentioned parameters, for example, the received data is stored in the hard disk 314 of the SFP 105. Distributed printing of the job C is performed in a print form compliant with the processing conditions. Namely, control is performed so that the SFP 105 is made to perform the operation 4 in FIG. 19. The control of the operation 4 may be performed principally by the control unit 210 of the SFP 105. Preferably, the operation 4 of the SFP 105 can be performed in parallel with (concurrently with) the operation 2 of the MFP 101 in FIG. 19. However, if a job in printing or in queue for printing already exists, distributed printing of the job C is performed after printing of the preceding job is completed.

The above-mentioned operations are performed in the second incompletely consistent distributive print mode. Thereafter, a user interface as in FIG. 9 is provided.

A plurality of setting change fields relating to a plurality of processing conditions having mutually different attributes may be displayed in the input field 900. For instance, in the example of display in FIG. 9, a sheet feeding mode setting change field 901 for making possible to change the setting of the sheet feeding mode is displayed in addition to the sheet discharge mode setting change field 903. Furthermore, control is performed so that a setting change field 902 relating to the print side such as double side printing/single side printing, and the like can be displayed.

Of course, all setting change fields may be displayed on the same screen, or setting change fields may be displayed on different screens for each item. Thus, any display configuration may be used. However, preferably, control is performed so that the parameter after the change of setting functions only for the incompletely consistent printing apparatus. In other words, control is performed so that processing compliant with processing specifics after the change of setting is not performed for the completely consistent printing apparatus. Namely, for explanation with the example in FIG. 19, processing conditions after the change of setting are incorporated for the SFP 105 among the MFP 101 and the SFP 105. On the other hand, control is performed so that the MFP 101 does not depend on processing conditions after change of setting. The control unit 201 performs control so that the MFP 101 is made to perform distributed printing in an output form compliant with the initial processing conditions (1) to (7) set by the user at step S1.

A button 904 on the screen of FIG. 9 is a determination button indicating determination of the changed setting specifics, and a button 905 is a cancellation button.

Thus, in the case of this embodiment, the SFP 105 which is a remote printing apparatus has no staple function. Therefore, the item of staple of the sheet discharge mode 903 is displayed in gray-out. The control unit 201 performs control so that a change of setting of finishing other than staple can be accepted from the user via the sheet discharge mode setting change field 903. Thereafter, printing process in the SFP 105 is performed. When the user completes the setting and operates the determination button 904, control is performed so that the changed specific is determined, and an instruction to start printing according to the setting specifics after change is provided. When the cancellation button 905 is operated by the user, the display unit 306 is controlled to make a return to the display screen of FIG. 8.

In FIG. 9, the setting screen of only the SFP 105 is displayed in accordance with this embodiment, but if a plurality of remote printing apparatuses are selected in the cluster printing setting, when the determination button 904 is selected for a certain printing apparatus, setting screens for other printing apparatuses are displayed to accept a change of setting specifics, and when the determination button 904 is operated for the last printing apparatus, an instruction to start printing is provided with specifics after the change of setting.

At step S19, for the MFP 101, a job compliant with the allocated setting specifics is generated by the general control manager 405 in the same manner as described above, and printing process is performed. If an additional remote printing apparatus capable of processing compliant with setting specifics is present although not present in this embodiment corresponding to the flowcharts of FIGS. 5A and 5B, a job compliant with the setting specifics allocated to the remote printing apparatus is generated by the general control manager 405 in the same manner, and sent to each remote printing apparatus via the network 104, and printing process is performed.

For the remote printing apparatus with the setting specifics changed, the general control manager 405 generates a job compliant with the changed setting specifics, and sends the job to the remote printing apparatus via the network 104. More specifically, in the case of this embodiment, for example, if sort is selected in the screen of FIG. 9, the general control manager 405 of MFP 101 generates a job for performing sort processing instead of staple processing as a job for the SFP 105, and sends the job to the SPF 105 via the network 104. Accordingly, on the SPF 105 side, sort processing is performed together with printing process compliant with other setting specifics excluding staple processing.

Thus, if the partner setting manual change button 804 is selected, cluster printing can be carried out with the setting specifics of the remote printing apparatus changed within the range allowing processing to be performed. Namely, distributed printing with the second incompletely consistent distributive print mode can be performed in the system.

If it is determined at step S17 that a partner setting manual change reception button 804 has not selected, processing proceeds to step S20, where whether or not the cancellation button 805 has been selected is determined. If it is determined that the cancellation button 805 has been selected, processing is ended. If it is determined that the cancellation button 805 has not been selected, processing returns to step S15, where processing is continued.

As described above, in this embodiment, various mechanisms are employed if there are setting specifics incapable of being dealt with by the remote printing apparatus when the remote printing apparatus is used for performing distributed printing or the like.

For example, as described above, display showing setting specifics of processing conditions initially desired by the user is provided. In addition, display showing setting specifics of the processing conditions incapable of being performed by the remote printing apparatus is provided. In this way, control is performed so that the user is notified of the fact that cluster printing cannot be performed in accordance with the setting initially desired by the user. In this way, this fact is recognized by the user.

Moreover, in this embodiment, use of the remote printing apparatus is not immediately given up because such a case occurs, but effective use of the overall system is taken into consideration. For example, even in such a case, the remote printing apparatus can be used wherever possible. However, a consideration in which the control unit of the system automatically determines use of the apparatus in a dictatorial manner, or the like, is not employed. Preferably, consideration is given to the user as in this embodiment.

For example, if the case described above occurs, first, the user is notified of the fact by the above-mentioned notification method. For example, the user is notified of the fact that incompletely consistent distributed printing cannot be performed, by the UI. Thereafter, the user himself can determine how to cope with this fact by the system. For example, a selection can be made by the user on whether or not incompletely consistent distributed printing can be performed. In addition, control is performed so that the user is notified of selection candidates as to what sort of measure is possible when determination is left to the user in this way. As an example thereof, the UI screen of FIG. 8 is displayed. In this way, the user determination is supported.

In this way, even if the above-mentioned case occurs, processing to be performed next can be easily continued. In other words, a variety of ways of use by the user using the print system can be flexibly coped with. Accordingly, even if printing apparatuses having no common function are connected to the network to construct the system, a trouble among printing apparatuses is detected, and the trouble is easily avoided. A user interface for this purpose can be provided. Namely, the problems conceived in the conventional technique are alleviated wherever possible, thus making it possible to obtain the various kinds of effects described above.

In the embodiment described above, processing is ended when the cancellation button 805 is operated in the screen shown in FIG. 8, but the following processing may be performed.

First, when the cancellation button 805 is operated, all processing allocated to the remote printing apparatus incapable of performing the setting specifics may be allocated to the local printing apparatus to continue cluster printing. Of course, the job end processing described above may be performed. Specifically, control is performed so that image data of the job is deleted from the storage device 304 (and/or storage device 314) in which image data of the job is stored for distributed printing. If there are other jobs in queue for printing, control is performed so that other jobs are sequentially printed instead. For example, processing may return to step S1.

If cluster printing is performed by the local printing apparatus and a plurality of remote printing apparatuses, the cluster printing setting screen shown in FIG. 10 may be redisplayed to divide all processing allocated to a remote printing apparatus incapable of performing the setting specifics among other printing apparatuses to continue cluster printing.

In explanation with FIGS. 8, 9 and 19, the example of incompletely consistent distributed printing by the MFP 101 and the SFP 105 corresponding to printing apparatuses having mutually different functions has been described. For example, the MFP 101 corresponds to a printing apparatus having both of a copy function of printing data read by the scanner unit of the self apparatus using the printer unit of the self apparatus and a print function of printing data from an external apparatus. The SFP 105 corresponds to a printing apparatus not having a copy function (at least scan function) but having a print function. In this way, distributed printing by printing apparatuses of different types is possible. However, preferably, incompletely consistent distributed printing can be performed even by printing apparatuses of the same type. This is because it is taken into consideration that even if the MFP 101 and the MFP 102 are printing apparatuses having the same functions, the case where incompletely consistent distributed printing should be coped with may arise according to some circumstance. One example thereof will be shown below.

For example, an instruction to perform distributed printing by the MFP 101 and the MFP 102 is requested by a user (hereinafter referred to user D) for a job (hereinafter referred to as job D) via the screen of FIG. 7 with the UI of the MFP 101. At this time (in processing at step S1 in the example in FIG. 5A), a series of processing conditions including at least a plurality of setting items described below is indicated by the user as printing process conditions for the job D.

(Processing condition 1) “A4 size” is set for the output sheet size.

(Processing condition 2) “Recycled paper” is set for the output sheet type.

(Processing condition 3) “Double side printing” is set for single side printing or double side printing.

(Processing condition 4) “Staple” is set for finishing.

(Processing condition 5) “20” is set for the number of print copies.

The above various settings are made by the user D, and then a request for processing the job D is accepted by the control unit 201 of the MFP 101. Thereupon, for example, the control unit 201 of the MFP 101 checks functional information of the MFP 101 and the MFP 102 in the management table of FIG. 11 at step S11. Current status information or the like of the apparatus including at least information of the residual amount of consumable material of these printing apparatuses is checked. The number of print copies, “20” is the total number of print copies of the job D. Therefore, 10 copies are allocated to each of the MFP 101 and the MFP 102.

In the determination at step S11, the control unit 201 of the MFP 101 determines that printing process meeting all of the above-mentioned processing conditions 1 to 5 can be performed by the MFP 101. As a reason thereof, for example, the control unit 201 recognizes that sheets of “A4 size and recycled paper” exist in the sheet feeding unit of the MFP 101. In addition, it is determined that the MPF 101 has a double side printing unit and can perform double side printing. In addition, it is determined that the MPF 101 has a finisher unit and can perform a staple function. The determination is based on such situations.

However, in the determination at step S11, the control unit 201 of the MFP 101 determines that printing process meeting all of the above-mentioned processing conditions cannot be performed by the MFP 102. Specifically, it is determined that the printing process can meet processing conditions other than the processing condition (2), but cannot meet the processing condition (2). As a reason thereof, for example, the control unit 201 of the MFP 101 recognizes that sheets of “A4 size and normal paper” exist in the sheet feeding unit of the MFP 102 based on status information acquired from the MFP 102. However, it is recognized that sheets of “A4 size and recycled paper” are not set in the MFP 102. In addition, it is determined that the MPF 102 has a double side printing unit and can perform double side printing. In addition, it is determined that the MPF 102 has a finisher unit and can perform a staple function. The determination is based on such situations.

Based on the recognition results described above, the control unit 201 of the MPF 101 makes a determination of NO at step S11. In this case, control is performed so that distributed printing by the MFP 101 and the MFP 102 is not forcefully prohibited from being performed. For example, in this case, control is performed so that processing proceeds to step S15 in. FIG. 5B. The UI is made to provide display such as display of the UI in FIG. 8.

By displaying the above-mentioned UI screen, control is performed so that the user D is notified of the fact that completely consistent distributed printing process of the job D cannot be performed, and the reason thereof. In addition, the notification of specifics of candidates of measures against this fact is made. Control is performed a measure to be carried out can be determined by the user via any of keys 803 to 805. For example, if the key 803 is pressed down by the user, control is performed so that first incompletely consistent distributed printing can be performed by the MFP 101 and the MFP 102 for the job D at step S16. For example, if the key 803 is pressed down by the user, second incompletely consistent distributed printing can be performed by the MFP 101 and the MFP 102 for the job D at step S19.

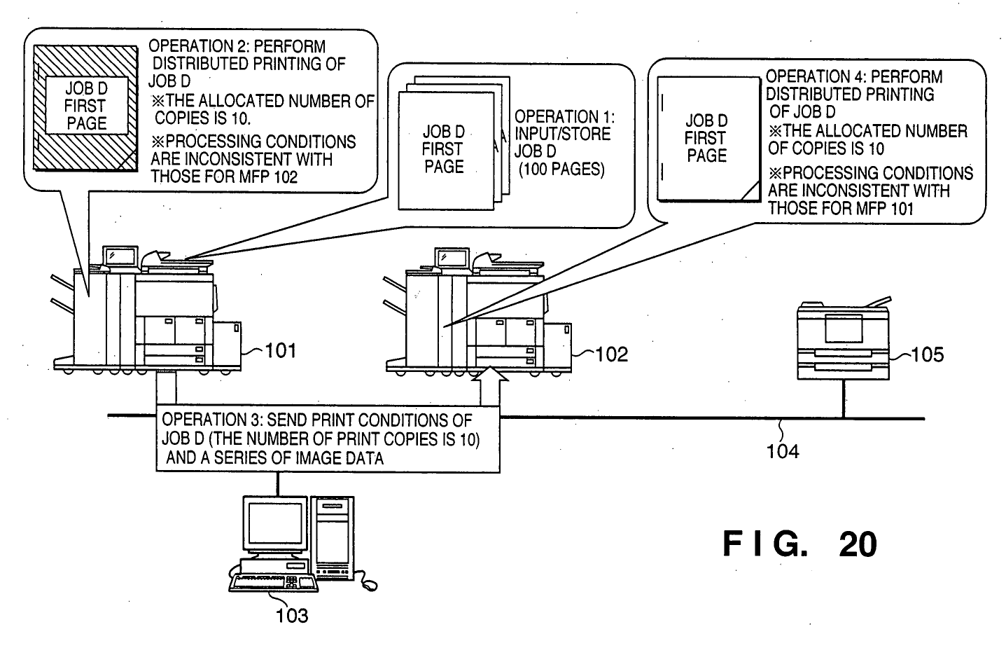

By the above-mentioned control, for example, the following operations are performed by each of the MFP 101 and the MFP 102 as incompletely consistent distributed printing of the job D. The operations will be described using FIG. 20.

First, the MFP 101 is made to perform operation (1) in FIG. 20. For example, in the MFP 101, document data (a series of document data of 100 pages in A4 size) of the job D is sequentially stored in the hard disk of the storage device 304 of the self apparatus.

If other jobs in printing do not exist in the MFP 101, or other jobs in queue for printing do not exist in the MFP 101, operation (2) in FIG. 20 is preferably performed by the MFP 101 in parallel with (substantially concurrently with) the operation (1) in FIG. 20. In the operation (2), for example, document data of the job D stored in the above-mentioned memory is subjected to double side printing using output sheets of “A4 size and recycled paper”. In addition, staple processing is performed in the unit of one copy. The MFP 101 is made perform such distributed printing in an amount equivalent to the allocated number of copies, i.e. 10 copies.

The MFP 101 is made to perform operation (3) in FIG. 20 in parallel with (substantially concurrently with) the operation (2) in FIG. 20. A series of data relating to the job D, stored in the above-mentioned memory of the MFP 101, is sent to the MFP 102. Data which is sent includes, for example, document data of the job D and processing condition data for, the job D. The number of copies of the job D allocated to each MFP is 10. Thus, the data of the allocated number of copies is sent together with the processing condition data. The sheet type “is recycled paper” in the MFP 101, but this indication is cancelled in the MFP 102. Thus, a command is sent so that “normal paper” is set for the sheet type in distributed printing of the job D in the MFP 102.

On the other hand, in the MFP 102, for example, if jobs in printing or jobs in queue for printing do not exist in the MFP 102, operation (4) in FIG. 20 is preferably performed in parallel with (concurrently with) the operation (2) in FIG. 20. For the MFP 102, the setting for using output sheets of “A4 size and recycled paper” is cancelled. Therefore, in the operation (4), for example, using output sheets of “A4 size and normal paper” instead of the above setting, document data of the job D from the MFP 101, stored in the hard disk of the MFP 102, is subjected to double side printing by the MFP 102. In addition, staple processing is performed in the unit of one copy. Such distributed printing is performed by the MFP 102 in an amount equivalent to the allocated number of copies, i.e. 10 copies.

The above operations (1) to (4) in FIG. 20 are performed to quickly obtain total 20 sets of output results with part of the print form of the job D different between the MFP 101 and the MFP 102 as in FIG. 20.

Thus, control is performed so that incompletely consistent distributive processing different in some of processing conditions can be performed by the MFP 101 and the MFP 102 for the job D.

If the default setting for the output sheet type in the MPF 102 is “normal paper” and first incompletely consistent distributed printing is performed at step 16, “normal paper” is automatically selected in the MFP 102. In second incompletely consistent distributed printing, “normal paper” is selected in the MFP 102 if the user selects “normal paper” at step S18.

Thus, in this embodiment, various forms of incompletely consistent distributed printing process can be performed by the system. Namely, in this example, the setting of finishing and the setting for the type of output sheets are illustrated as examples of processing conditions different between the completely consistent printing apparatus and the incompletely consistent printing apparatus. However, in addition thereto, a processing condition for print layout, a processing condition for setting of double side printing or single side printing, and processing conditions directly associated with the print output form, such as the sheet size and scaling factor setting exist. Therefore, although not specifically illustrated, such processing conditions may be applicable as one example of processing conditions different between the completely consistent printing apparatus and the incompletely consistent printing apparatus.

In this example, one processing condition is different between the completely consistent printing apparatus and the incompletely consistent printing apparatus when incompletely consistent distributed printing process is performed. However, control may be performed so that distributed printing in an output form with two or more processing conditions made different between both types of apparatuses can be performed by these printing apparatuses. One example thereof will be shown below.

For example, the SFP 105 has neither a double side printing function nor a staple function. The MFP 102 has both the double side printing function and staple function. In this situation, a user (hereinafter referred to as user E) requests distributed printing using these two printing apparatuses via the screen of FIG. 7 displayed on the display unit of the MFP 102. In addition, the user E sets at least a plurality of processing conditions described below, for a job (hereinafter referred to as job E) for the distributed printing, at step S1.

(Processing condition 1) “A4 size” is set for the output sheet size.

(Processing condition 2) “Normal paler” is set for the output sheet type.

(Processing condition 3) “Double side printing” is set for single side printing or double side printing.

(Processing condition 4) “Staple” is set for finishing.

(Processing condition 5) “100” is set for the number of print copies.

In this case, the control unit of the MFP 102 performs control so that the following operations can be performed by, for example, the MFP 102 and the SFP 105, as incompletely consistent distributed printing of the job E through processing at step S16 or step S19.

In the MFP 102, using output sheets of “A4 size and normal paper”, double side printing is performed. In addition, staple processing is performed in the unit of one copy. The MFP 102 is made to perform such distributed printing for the job E is in an amount equivalent to the allocated number of copies, i.e. 50 copies.

On the other hand, for the SFP 105, two settings of “double side printing” and “staple” are cancelled. “Single side printing” is performed instead of “double side printing” using output sheets of “A4 size and normal paper”. In addition, “shift discharge” is performed for each one copy of output sheets instead of “staple”. Such distributed printing for the job E is performed by the SFP 105 in an amount equivalent to the allocated number of copies, i.e. 50 copies.

Thus, control is performed so that incompletely consistent distributive processing in a print form with at least two different processing conditions can be performed by the MFP 102 and the SFP 105 as distributive processing of the job E.

As described above, various configurations can be applied in the system. However, even if these various kinds of configurations are employed, various kinds of controls described above are preferably performed. For example, even in the configuration described above, the UI is controlled so that display shown in FIG. 8 can be provided before the incompletely consistent distributed printing operation is actually performed. In addition, a selection can be made on whether or not the operation can be performed by the user via the UI. In addition, control is performed so that incompletely consistent distributed printing can be performed by each printing apparatus after a consensus is got from the user of the job. In other words, control is performed so that the incompletely consistent distributed printing is prohibited from being performed if a message indicating that the use does not concede is input via the UI. Thus, it is desirable that the system should be flexibly constructed to the effects that the effect of this embodiment can be held. For further improving the effect of making it possible to cope with various user needs for distributed printing, as one effect of this embodiment, the following configuration may be incorporated. For example, as one of initial setting registrations for the printing apparatus, the initial setting for distributed printing can be set by the user via the UI. Preferably, a user authorized to some extent, such as a manager, can make the setting.

As one of the settings, for example, if a determination of NO is made in the setting at step S12, the UI is made to display a distributed printing initial setting screen (not shown) for previously making a setting on whether performance of incompletely consistent distributed printing is permitted or prohibited.

When a setting for prohibiting performance of incompletely consistent distributed printing is made by the user via the distributed printing initial setting screen, the control unit registers the setting in a nonvolatile memory as registration information. If this setting is made for the printing apparatus, the control unit controls the printing apparatus as follows.

For example, after the above-mentioned initial setting is made in the MFP 101, the MFP 101 newly accepts a job (hereinafter referred to as job F) (corresponding to YES at step S2). The control unit 201 checks information of the job F and resultantly determines that the job F is a job of a distributed printing request (corresponding to YES at step S9 in FIG. 5A). However, as a result of the determination at step S12, it is determined that the job F is a job incapable of performing completely consistent distributed printing (corresponding to NO at step S12 in FIG. 5A). Then, the control unit 201 makes a reference to the above-mentioned initial setting information. As a result, the control unit 201 recognizes that an initial setting has been made for prohibiting performance of incompletely consistent distributed printing. Therefore, the control unit 201 prohibits the job F from being processed with incompletely consistent distributed printing by the system. In this case, preferably, the display unit 306 is made to provide warning display or the like. For example, a display screen having display fields 801 and 802 of FIG. 8 is displayed. However, incompletely consistent distributed printing is prohibited. Therefore, control is performed so that the display unit 306 is prohibited from providing effective display making it possible to select the key 803 or 804 by the user. For example, these keys re displayed in halftone or gray-out. Alternatively, the keys themselves are not displayed. In this way, input of an instruction to perform incompletely consistent distributed printing by the user of the job F is prohibited. By this method, performance of incompletely consistent distributed printing is prohibited. In this case, preferably, in the flow of FIGS. 5A and 5B, the display unit 306 is made to provide the above-mentioned warning display according to the determination of NO at step S12, and then processing proceeds to step S1.

On the other hand, assume that the setting for permitting performance of incompletely consistent distributed printing is registered by the user (this user is not the user of the job F but a manager or the like) via the distributed printing initial setting screen. In this case, the control unit 201 permits procession of processing to step S14 as processing of the job F. Namely, the control unit 201 permits performance of incompletely consistent distributed printing of the job F. For example, a screen as in FIG. 8 for the job F is displayed at step S14. When the key 803 is pressed down, first incompletely consistent distributed printing is performed for the job F at step S16. Alternatively, when the key 804 is pressed down, second incompletely consistent distributed printing is performed for the job F at step S19.

The function described above may be incorporated in the system.

In the above example, incompletely consistent distributed printing with two or more processing conditions different between the completely consistent printing apparatus and the incompletely consistent printing apparatus is illustrated. In this connection, for example, it may be made possible to register the number of processing conditions permitted to be different, as an initial setting for distributed printing, by the user (preferably manager).

For example, when a setting for permitting incompletely consistent distributed printing is made on the above-mentioned distributed printing initial setting screen, display making it possible to input the number of processing conditions permitted to be different through the key by the user is provided.

For example, if a setting of “three processing conditions permitted” or the like is made under such a configuration, operations are performed as follows.

For example, after this initial setting is made, a new job (hereinafter referred to as job G) is accepted (corresponding to YES at step S2) in the MFP 101.

The control unit 201 checks information of the job G and resultantly determines that the job F is a job of a distributed printing request (corresponding to YES at step 9 in FIG. 5A). In addition, for example, it is recognized that the MFP 101 and the SFP 105 have been selected as distributed printing partners.

Here, the control unit 201 determines that the job G is a job incapable of performing completely consistent distributed printing (corresponding to NO at step S12 in FIG. 5A) as a result of the determination at step S12. Further, the control unit 201 determines the number of processing conditions which cannot be met among a plurality of processing conditions set by the user, based on job information of the job G and information of functions and statuses of apparatuses. Further, the number of processing conditions which cannot be met by the specified slave printing apparatus (corresponding to the SFP 105 in this example) among a plurality of processing conditions set by the user for the job G is compared with the parameter “3” registered in the above-mentioned distributed printing initial setting.

For example, as a result, it is determined that the number of processing conditions incapable of being performed by the slave apparatus (SFP 105 in this example) among a plurality of processing conditions set by the user for the job G is 4 or more.

In this case, the control unit 201 prohibits processing of the job G by the system with incompletely consistent distributed printing. Preferably, for example, the UI is made to display a display screen having display fields 801 and 802 of FIG. 8 as in the previous example. In this way, a user (hereinafter referred to as user G) of the job G is notified of the fact. However, performance of incompletely consistent distributed printing is prohibited, and therefore keys 803 and 804 are not selectable by the user G as in the previous example. In the flow of FIGS. 5A and 5B, the display unit is made to provide the above-mentioned warning display according to the determination of NO at step S12, and then processing proceeds to step S1.

On the other hand, assume that for example, the control unit 201 recognizes that the number of processing conditions incapable of being performed by the slave apparatus (SFP 105 in this example) among a plurality of processing conditions set by the user for the job G is “3”. Namely, the condition of “three processing conditions permitted to be different” in the above-mentioned distributed printing initial setting is met.

In this case, the control unit 201 permits procession of processing to step S14 as processing of the job G. Namely, the control unit 201 permits performance of incompletely consistent distributed printing of the job G. For example, the screen of FIG. 8 for the job G is displayed at step S14. When the key 803 is pressed down, the MFP 101 and the SFP 105 are controlled to perform first incompletely consistent distributed printing for the job G at step S16. Alternatively, when the key 804 is pressed down, the MFP 101 and the SFP 105 are controlled to perform second incompletely consistent distributed printing for the job G at step S19.

However, the MFP 101 is operated as in the above-mentioned form irrespective of whether first or second incompletely consistent distributed printing is performed. Namely, control is performed so that printing process of data of the job G for distributed printing is performed in a print output form compliant with all of a plurality of processing conditions initially set by the user G for the job G at step S1. In other words, in the SFP 105 of the other distributed printing partner, operations are performed as follows for the distributed printing job G.

For example, control is performed so that printing process of data of the job G is performed by the SFP 105 under processing conditions with at least three processing conditions different compared with processing conditions used in printing process of data of the job G by the MFP 101.

If the above-mentioned job E is matched with the sequence, the job E has two processing conditions incapable of being performed by the incompletely consistent printing apparatus, i.e. “staple” and “double side printing”. Therefore, if control is performed with the rule of “three processing conditions permitted to be different”, performance of incompletely consistent distributed printing with the job G is permitted for this job E.

A configuration other than the configuration in which control is performed so that whether or not incompletely consistent distributed printing can be performed can be determined based on initial setting information of “permitted/not permitted” or the like may be employed. As one example thereof, it may be made possible to determine whether or not incompletely consistent distributed printing can be performed based on the number of processing conditions incapable of being performed by the incompletely consistent printing apparatus as described above.

The function described above may be incorporated in the system. It is preferable that the system can be flexibly constructed in this way. Consequently, for example, a system giving consideration to convenience of the manager of the system and the like can be constructed. Namely, the above-mentioned effects of this embodiment can be further improved.

In examples in FIGS. 17 to 20, the source of image data is a reader unit of the printing apparatus on the master side. However, as described above, the candidate of the data source is not limited to the reader of the printing apparatus. For example, the case where the job from an external information processing apparatus such as the host computer 103 is printed distributively by a plurality of printing apparatuses can be coped with. In this case, the user of the job for distributed printing exists in the information processing apparatus from which data is generated. Therefore, various kinds of user interface screens described above are displayed on the display unit of the information processing apparatus. For example, if the job is received from the host computer 103 the job is provided to various kinds of UIs via a printer driver screen of the host computer 103. Such a configuration may be employed. Control is performed principally by the host computer.

As described above, this embodiment can make it possible to perform various kinds of operations described-above irrespective of which of a plurality of apparatuses (e.g. computer 103, MFP 101, MFP 102 and SFP 105 in FIG. 1, etc.) connected to the system is a master apparatus. By flexibly constructing the system in this way, the above-mentioned effects can be further improved.

### Second Embodiment

In the first embodiment, the case where cluster printing is performed by a plurality of printing apparatuses has been described, but in this embodiment, alternative printing in which printing by the local printing apparatus is all performed by the remote printing apparatus substitutively will be described.

Alternative printing in this embodiment means printing process in which printing is performed only by the remote printing apparatus. Alternative printing in this embodiment is similar in basic operation to cluster printing in the first embodiment. However, the former is significantly different from the latter in that the local printing apparatus also performs printing process in cluster printing in the first embodiment, while printing is performed only by the remote printing apparatus in alternative printing in this embodiment.

Thus, if in the flowchart corresponding to the first embodiment, shown in FIGS. 5A and 5B, matters relating to the local printing apparatus are excluded, and alternative printing (remote printing) is substituted for cluster printing, it will be a flowchart for alternative printing process of this embodiment.

For drawings of FIGS. 6 to 11, settings relating the local printing apparatus are no longer required in the case of alternative printing, and therefore if settings relating to the local printing apparatus are excluded, and the job is all allocated to the remote printing apparatus, they will be drawings corresponding to alternative printing process in this embodiment.

In this way, in this embodiment, when there are settings incapable of being dealt with by the remote printing apparatus, specifics set by the user and settings incapable of being dealt with are displayed to notify the user of the fact that alternative printing cannot be performed, the fact is recognized, and then next processing can easily be continued in the same manner as in cluster processing in the first embodiment, thus making it possible to cope with a variety of ways of use by the user using the print system. Accordingly, even if printing apparatuses having no common functions are connected to the network to construct the system, a trouble among printing apparatuses is detected, and the trouble is easily avoided. In addition, a user interface for this purpose can be provided.

As described above, according to the present invention, alternative printing and cluster printing can be performed among printing apparatuses having different functions in a system in which a plurality printing apparatuses are connected to be capable of mutually exchanging data. In addition, the convenience of the system can be increased. Namely, problems conceived in the conventional technique can-be solved to exhibit various kinds of effects described above.

### Other Embodiments

The present invention provides program codes of software for achieving the functions of the above described embodiments to a computer in an apparatus or system connected to various kinds of apparatuses so as to operate the apparatuses so that the functions of the embodiments described previously are achieved. For example, the program codes include programs for performing processing in the flowcharts of FIGS. 5A and 5B, and programs relating to various kinds of UIs described above. The system and/or the apparatus (CPU or MPU) are made to operate the various kinds of apparatuses according to the stored program. Implementations by this method are also included in the present invention.

In this case, the program codes of software themselves achieve the functions of the embodiment, and the program codes themselves and means for supplying the program codes to the computer, e.g. a storage medium storing such program codes constitute the present invention.

For the storage medium storing such program codes, for example, floppy® disks, hard disks, optical disks, magneto-optical disks, CD-ROMs, magnetic tapes, nonvolatile memory cards, ROMs and the like may be used.

Not only when the computer executes supplied program codes to achieve the functions of the embodiment described previously, but also when the program codes cooperate with an OS (operating system), other application software or the like collaborating in the computer to achieve the functions of the embodiment described previously, such program codes are included in the embodiment of the present invention as a matter of course.

When supplied program codes are stored in a memory provided in a feature expansion board of the computer or a feature expansion unit connected to the computer, then a CPU or the like provided in the feature expansion board or feature expansion unit performs part or all of actual processing based on instructions of the program codes, and the functions of the embodiment described previously are achieved by the processing, such program codes are included in the present invention as a matter of course.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application No. 2004-273977 filed on Sep. 21, 2004, and No. 2005-258313 filed on Sep. 6, 2005, which are hereby incorporated by reference herein.

What is claimed is:

1. A local printing apparatus capable of communicating with at least one remote printing apparatus, comprising:
a first setting unit accepting a setting of printing process using said remote printing apparatus;
a function information acquiring unit acquiring function information related to functions of said remote printing apparatus;
a determination unit determining whether or not said remote printing apparatus can perform printing process corresponding to said setting based on said function information;
a second setting unit further accepting a setting of corresponding printing process in said remote printing apparatus if said determination unit determines that said remote printing apparatus cannot perform printing processing corresponding to said setting; and
a print controller generating a print job in accordance with the setting accepted in said second setting unit, and sending the print job to said remote printing apparatus.

2. The local printing apparatus according to claim 1, wherein said second setting unit accepts a setting for performing printing process in said remote printing apparatus excluding printing process which cannot be performed by said remote printing apparatus.

3. The local printing apparatus according to claim 1, wherein said second setting unit accepts a setting for changing printing process which cannot be performed by said remote printing apparatus to other printing process.

4. The local printing apparatus according to claim 1, wherein said second setting unit accepts a setting for allocating printing process set in said remote printing apparatus which cannot perform said printing process to said local printing apparatus.

5. The local printing apparatus according to claim 1, wherein said second setting unit accepts a setting for allocating printing process set in said remote printing apparatus which cannot perform said printing process to other said remote printing process.

6. The local printing apparatus according to claim 1, wherein printing process using said remote printing apparatus is cluster printing process in which printing is performed distributively by said local printing apparatus and said remote printing apparatus.

7. The local printing apparatus according to claim 1, wherein printing process using said remote printing apparatus is alternative printing process in which printing is performed only by said remote printing apparatus.

8. A method for controlling a local printing apparatus capable of communicating with at least one remote printing apparatus, comprising:
a first setting step of accepting a setting of printing process using said remote printing apparatus;
a function information acquiring step of acquiring function information related to:functions of said remote printing apparatus included in said setting;
a determination step of determining whether or not said remote printing apparatus can perform printing process corresponding to said setting based on said function information;
a second setting step of further accepting a setting of corresponding printing process in said remote printing apparatus if it is determined at said determination step that said remote printing apparatus cannot perform printing process corresponding to said setting; and
a print controlling step of generating a print job in accordance with the accepted setting at said second setting step, and sending the print job to said remote printing apparatus.

9. A computer program for making a computer perform the method for controlling a local printing apparatus set out in claim 8.

10. A computer readable storage medium storing the computer program set out in claim 9.

11. A job processing method comprising steps of:
accepting a request related to a distributed printing which is printing process executed by using both a first printing apparatus and a second printing apparatus; and
causing said second printing apparatus to perform a printing process of data for said distributed printing with processing conditions that is different from processing conditions in a printing process of data for said distributed printing by said first printing apparatus.

12. The method according to claim 11, further comprising:
enabling, selectively, an execution of a first sequence in which printing process of data for said distributed printing is performed by said second printing apparatus under processing conditions same as processing conditions in printing process of data for said distributed printing by said first printing apparatus and a second sequence in which printing process of data for said distributed printing is performed by said second printing apparatus under processing conditions different from processing conditions in printing process of data for said distributed printing by said first printing apparatus.

13. The method according to claim 11, further comprising:
enabling an execution of a printing process of data for said distributed printing by said second printing apparatus under processing conditions same as processing conditions in printing process of data for said distributed printing by said first printing apparatus, in case that said second printing apparatus can follow all of processing conditions initially requested by user; and
enabling an execution of a printing process of data for said distributed printing by said second printing apparatus under processing conditions different from processing conditions in printing process of data for said distributed printing by said first printing apparatus, in case that said second printing apparatus can not follow all of processing conditions initially requested by user.

14. The method according to claim 11, further comprising:
enabling an execution of a selection on whether or not printing process of data for said distributed printing by said second printing apparatus under processing conditions different from processing conditions in printing process of data for said distributed printing by said first printing apparatus, via a user interface unit, by user, before said printing process of data for said distributed printing is started by said second printing apparatus.

15. The method according to claim 11, further comprising:
causing said second printing apparatus to perform said printing process of data for said distributed printing with processing conditions that is different from processing conditions in said printing process of data for said distributed printing by said first printing apparatus, in accordance with a request from an user, even if said second printing apparatus can not follow all of processing conditions initially requested by the user.

16. The method according to claim 11, further comprising:
causing said second printing apparatus to perform said printing process of data for said distributed printing when a predetermined instruction from an user is input via an user interface unit even if said second printing apparatus can not follow all of processing conditions initially requested by the user; and
inhibiting an execution of said printing process of data for said distributed printing in case that said predetermined instruction is not input via said user interface unit.

17. The method according to claim 11, further comprising:
causing said second printing apparatus to perform said printing process of data for said distributed printing under processing conditions partially consistent with processing conditions in printing process by said first printing apparatus, even if said printing process of data for said distributed printing is performed by said second printing apparatus under processing conditions different from processing conditions in printing process of data for said distributed printing by said first printing apparatus.

18. The method according to claim 11, further comprising:
causing said second printing apparatus to perform said printing process of data for said distributed printing under processing conditions different from processing conditions in printing process of data for said distributed printing by said first printing apparatus, in case that the number of processing conditions incapable of being performed by said second printing apparatus among a plurality of processing conditions for data for said distributed printing is equal to or less than a predetermined number.

19. The method according to claim 18, further comprising:
inhibiting an execution of said printing process of data for said distributed printing under processing conditions different from processing conditions in printing process of data for said distributed printing by said first printing apparatus, in case that the number of processing conditions incapable of being performed by said second printing apparatus among a plurality of processing conditions for data for said distributed printing is not equal to or less than a predetermined number.

20. The method according to claim 11, further comprising:
enabling an execution at least one of a first operation in which printing process of data for said distributed printing is performed by said second printing apparatus under processing conditions same as processing conditions in printing process of data for said distributed printing by said first printing apparatus and a second operation in which printing process of data for said distributed printing is performed by said second printing apparatus under processing conditions different from processing conditions in printing process of data for said distributed printing by said first printing apparatus.

21. The method according to claim 20, further comprising:
enabling an execution at least one of a first mode in which processing conditions different from processing conditions in printing process of data for said distributed printing by said first printing apparatus are automatically set and a second mode in which processing conditions different from processing conditions in printing process of data for said distributed printing by said first printing apparatus are manually set, in said second operation.

22. The method according to claim 11, further comprising:
enabling, selectively, an execution of a first mode in which processing conditions different from processing conditions in printing process of data for said distributed printing by said first printing apparatus are automatically set and an execution of a second mode in which processing conditions different from processing conditions in printing process of data for said distributed printing by said first printing apparatus are manually set, in case that said printing process of data for said distributed printing is performed by said second printing apparatus under processing conditions different from processing conditions in printing process of data for said distributed printing by said first printing apparatus.

23. The method according to claim 11, wherein said second printing apparatus includes a printing apparatus with the number of functions smaller than the number of functions possessed by said first printing apparatus.

24. The method according to claim 23,
wherein said second printing apparatus includes a printing apparatus not having a scan function but having a print function; and
said first printing apparatus includes a printing apparatus having said scan function and said print function.

25. The method according to claim 11, wherein if said first printing apparatus is a printing apparatus having said scan function and said print function, and said second printing apparatus is a printing apparatus not having said scan function but having said print function, printing process of data for said distributed printing can be performed by said second printing apparatus under processing conditions different from processing conditions in printing process of data for said distributed printing by said first printing apparatus.

26. The method according to claim 11, wherein even if said first printing apparatus and said second printing apparatus are printing apparatuses both having said scan function and said print faction, printing process of data for said distributed printing can be performed by said second printing apparatus under processing conditions different from processing conditions in printing process of data for said distributed printing by said first printing apparatus.

27. The method according to claim 11, further comprising:
causing said second printing apparatus to perform said printing process of data for said distributed printing in parallel with said printing process of data for distributed printing by said first printing apparatus, in case that other job in printing does not exist in said second printing apparatus.

28. The method according to claim 27, further comprising:
causing said first printing apparatus to perform said printing process of data for said distributed printing after printing of other job is completed in said first printing apparatus, in case that the other job in printing exists in said first printing apparatus.

29. The method according to claim 27, further comprising:
causing said second printing apparatus to perform said printing process of data for said distributed printing after printing of other job is completed in said second printing apparatus, in case that the other job in printing exists in said second printing apparatus.

30. The method according to claim 11, wherein said first printing apparatus and said second printing apparatus include printing apparatuses comprising a storage unit capable of storing image data of a plurality of jobs.

31. The method according to claim 11, wherein at least said first printing apparatus of said first printing apparatus and said second printing apparatus includes a printing apparatus comprising an original reading unit performing read processing of an original and a storage unit capable of storing image data of a plurality of jobs.

32. The method according to claim 11, further comprising:
causing said first printing apparatus to send data for said distributed printing to said second printing apparatus in case that said printing process of data for said distributed printing is performed by said second printing apparatus is performed under processing conditions different from processing condition in printing process of data for said distributed printing by said first printing apparatus.

33. The method according to claim 32, further comprising:
causing said first printing apparatus to send data for said distributed printing to said second printing apparatus in parallel with said printing process of data for said distributed printing by said first printing apparatus.

34. The method according to claim 11, wherein said processing conditions include printing process conditions directly related to a print output form.

35. The method according to claim 11, wherein said processing conditions include processing conditions other than a setting related to the number of print copies, including any of a setting related to the size of a print sheet, a setting related to the type of the print sheet, a setting related to a print scaling factor, a setting related to a print layout, a setting related to single side printing or double side printing and a setting related to finishing.

36. The method according to claim 11, wherein it is made possible to selectively perform:
a first operation in which printing process of data for said distributed printing is performed by said second printing apparatus under processing conditions same as processing conditions in printing process of data for said distributed printing by said first printing apparatus; and
a second operation in which printing process of data for said distributed printing is performed by said second printing apparatus under processing conditions different from processing conditions in printing process of data for said distributed printing by said first printing apparatus, and
the number of print copies is equally allocated to said first printing apparatus and said second printing apparatus if any of said first operation and said second operation is performed.

37. The method according to claim 11, wherein it is made possible to selectively perform:
a first operation in which printing process of data for said distributed printing is performed by said second printing apparatus under processing conditions same as processing conditions in printing process of data for said distributed printing by said first printing apparatus; and
a second operation in which printing process of data for said distributed printing is performed by said second printing apparatus under processing conditions different from processing conditions in printing process of data for said distributed printing by said first printing apparatus, and
the number of print copies is allocated according to a difference in speed between said first printing apparatus and said second printing apparatus if any of said first operation and said second operation is performed.

38. The method according to claim 11, further comprising:
causing said second printing apparatus to perform a second operation of a first operation in which printing process of data for said distributed printing is performed by said second printing apparatus under processing conditions same as processing conditions in printing process of data for said distributed printing by said first printing apparatus and the second operation in which printing process of data for said distributed printing is performed by said second printing apparatus under processing conditions different from processing conditions in printing process of data for said distributed printing by said first printing apparatus, in case that the first operation cannot be performed.

39. The method according to claim 38, wherein if it is impossible to perform the first operation in which printing process of data for said distributed printing is performed by said second printing apparatus under processing conditions same as processing conditions in printing process of data for said distributed printing by said first printing apparatus, information related thereto is detected by a user interface unit.

40. The method according to claim 39, wherein after said information is detected by a user interface unit, the user can make a selection on whether or not said second operation can be performed via said user interface unit.

41. The method according to claim 39,
wherein if after said information is detected by a user interface unit, a user instruction to perform said second operation is input via said user interface unit, said second operation is performed instead of said first operation; and
if after said information is detected by a user interface unit, a user instruction to perform said second operation is not input via said user interface unit, said second operation is prohibited from being performed.

42. The method according to claim 11,
wherein a source of data for said distributed printing includes at least any of an original reading unit possessed by said first printing apparatus and a host computer; and
said request can be accepted from the user via a user interface unit possessed by said first printing apparatus.

43. The method according to claim 11,
wherein the source of data for said distributed printing includes at least any of an original reading unit possessed by said first printing apparatus and a host computer; and
said request can be accepted from the user via a user interface unit possessed by said host computer.

44. The method according to claim 11, wherein distributed printing of data for said distributed printing can be performed using only two printing apparatuses: said first printing apparatus and said second printing apparatus.

45. The method according to claim 11, wherein distributed printing of data for said distributed printing can be performed using not only two printing apparatuses: said first printing apparatus and said second printing apparatus, but also a larger number of printing apparatuses.

46. A print system for performing the job processing method set out in claim 11.

47. A printing apparatus for performing the job processing method set out in claim 11.

48. A computer readable storage medium storing a computer program for performing the job processing method set out in claim 11.

49. A computer program form making a computer perform the job processing method set out in claim 11.
